(19) United States
(12) Patent Application Publication
(10) Pub. No.: US 2025/0144562 A1
(43) Pub. Date: May 8, 2025

(54) ELECTROCHEMICAL CO2 CAPTURE WITH AIR STABLE REDOX SPECIES

(71) Applicant: President and Fellows of Harvard College, Cambridge, MA (US)

(72) Inventors: Yan JING, Cambridge, MA (US); Shijian JIN, Cambridge, MA (US); Roy G. GORDON, Cambridge, MA (US); Michael J. AZIZ, Cambridge, MA (US)

(21) Appl. No.: 18/833,796

(22) PCT Filed: Jan. 26, 2023
(86) PCT No.: PCT/US2023/061376

§ 371 Date: Jul. 26, 2024

Related U.S. Application Data
(60) Provisional application No. 63/303,244, filed on Jan. 26, 2022.

(51) Int. Cl. B01D 53/32; B01D 53/62; B01D 53/78; B01D 53/96

(52) U.S. Cl. CPC B01D 53/326; B01D 53/62; B01D 53/78; B01D 53/965; B01D 2255/804; B01D 2255/806; B01D 2257/504; B01D 2258/0283; B01D 2258/06

(57) ABSTRACT

The invention features solutions of water-soluble, oxygen-resistant redox-active species circulated in flow cells to electrochemically capture CO₂ from air or flue gas and release pure CO₂. The method is safe, scalable, and potentially inexpensive, as it utilizes non-volatile and potentially low-cost redox organic and inexpensive inorganic species and can operate at ambient temperature and pressure and can operate at high current densities.

### BACKGROUND OF THE INVENTION

CO₂ can be captured from air or flue gas and release pure CO₂ through an electrochemical cycle. Molecules that undergo proton-coupled electron transfers (PCET) change the solution pH from near neutral to highly basic during charging, and from highly basic to near neutral during discharging. In other words, hydroxide is reversibly generated during charging and consumed during discharging. Since hydroxide binds with CO₂ to form bicarbonate and then carbonate, the electrolyte captures CO₂ upon charging and releases CO₂ upon discharging. The energy cost for capturing from a 0.1 bar CO₂ stream and releasing into a 1 bar stream at 40 mA/cm² costs 86 kJ/molCO₂, which is highly competitive compared to traditional amine scrubbing processes that typically cost more than 100 kJ/molCO₂.

In addition, electrochemical flow cell capture systems such as those described herein rely solely on electrical work, while amine scrubbing requires high thermal input, and the amines and related decomposition products are volatile and environmental hazards. For air capture, redox flow methods such as described herein are projected to cost 110 kJ/molCO₂ at 40 mA/cm², which is again very competitive compared with existing technologies costing more than 150 kJ/molCO₂.

Electrochemical CO₂ capture systems typically require an oxygen-free environment. This is because when the redox-active organic molecules are reduced (e.g., when the systems are charged), they may be susceptible to oxidation by molecular oxygen, thereby stopping the discharge process from happening, causing an incomplete cycle and, e.g., resulting an accumulation of hydroxide and dissolved carbon species in the electrolyte. Eventually the device will be fully oxidized in both sides and no longer functional. In real life application, a perfectly sealed flow battery is difficult to achieve. Even if initially perfectly sealed, external factors such as aging of cell components or the sealing material, extreme weather, geological changes or even vandalism may cause molecular oxygen to come into contact with the electrolyte. For carbon capture, molecular oxygen is almost always unavoidable, as there is 1 to 3% of oxygen in factory flue gas and ˜20% oxygen in air. Therefore, mitigating the adverse effect of oxygen is essential to electrochemical carbon capture flow cell.

### SUMMARY OF THE INVENTION

The invention features solutions of water-soluble, oxygen-resistant redox-active species circulated in flow cells to electrochemically capture CO₂, e.g., from air or flue gas, and release pure CO₂. The method is safe, scalable, and potentially inexpensive, as it utilizes non-volatile and potentially low-cost redox organic and inexpensive inorganic species and can operate at ambient temperature and pressure and can operate at high current densities.

In an aspect, the invention provides a method for capturing CO₂. The method includes providing an electrochemical cell including a redox-active species dissolved or dispersed in aqueous solution, electrochemically reducing the redox-active species to a reduced state, and contacting a mixture of gases including CO₂ with the aqueous solution. The redox-active species of the method may include an aromatic redox core and one or more substituents that increase resistance of the reduced state to oxidation by oxygen, and/or a redox potential of the redox-active species in its reduced state may be sufficiently high to be stable to oxidation by oxygen.

In some embodiments, the one or more substituents includes one or more electron withdrawing groups. In some embodiments, the electron withdrawing groups are separated from the redox core by one or more methylene units (e.g., (CH₂)₁₋₆) and/or an ether (—O(CH₂)₀₋₆—), a thioether (—S(CH₂)₀₋₆—), or a secondary (—NH(CH₂)₀₋₆—) or tertiary amine (—NRₐ(CH₂)₀₋₆—) unit. Exemplary electron withdrawing groups include —NO₂, —CN, —SO₃Rₐ, —CHO, —C(═O)Rₐ, —C(═O)O C(═O)Rₐ, —C(═O)ORₐ, (e.g., —C(═O)OH), —CONH₂, —COO⁻, —NRₐ₃⁺, —CF₃, —SO₂Rₐ, —F, —Cl, —Br, —I, —ORₐ, —SRₐ, —P(═O)(ORₐ)₂, —(CH₂)₁₋₃NO₂, —(CH₂)₁₋₃CN, —(CH₂)₁₋₃SO₃Rₐ, —(CH₂)₁₋₃CHO, —(CH₂)₁₋₃C(═O)Rₐ, —(CH₂)₁₋₃C(═O)OCORₐ, —(CH₂)₁₋₃COORₐ, —(CH₂)₁₋₃C(═O)OH, —(CH₂)₁₋₃CONH₂, —(CH₂)₁₋₃C(═O)O—, —(CH₂)₁₋₃NRₐ₃⁺, —(CH₂)₁₋₃SO₂Rₐ, —CH₂CF₃, —CH₂CCl₃, —CH₂CBr₃, —CH₂Cl₃, —CH₂CHF₂, —CH₂CHCl₂, —CH₂CHBr₂, —CH₂CHI₂, —CH₂(CF₂)₁₋₆CF₃, —(CH₂)₁₋₃ORₐ, and —(CH₂)₁₋₃SRₐ, where each Rₐ is independently H; optionally substituted C₁₋₆ alkyl; optionally substituted C₃₋₁₀carbocyclyl; or optionally substituted C₁₋₉ heterocyclyl having one to four heteroatoms independently selected from O, N, and S, e.g., —SO₃H, —PO₃H₂, —COOH, —OH, —NH₂, —N(CH₃)₃⁺, —NH₃⁺, and ethylene glycol (—OCH₂CH₂OCH₂CH₂OH).

In some embodiments, the one or more substituents are optionally substituted C₁₋₆ alkyl groups including a quaternary ammonium group, optionally substituted C₁₋₆ alkoxy groups including a quaternary ammonium group, optionally substituted C₁₋₆ alkyl thio groups including a quaternary ammonium group. In some embodiments, the quaternary amine group is attached to a terminal carbon. In some embodiments, the one or more substituents include at least one —(CH₂)ₙNRₐ₃⁺ group, where n=2-11, where each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; or optionally substituted C₁₋₉ heteroaryl having one to four heteroatoms independently selected from O, N, and S; or a nitrogen protecting group.

In some embodiments, the aromatic redox core includes para or ortho benzoquinone, naphthoquinone, anthraquinone, phenanthrenequinone, fluorenone, benzophenone, anthrone, xanthone, thioxanthone, acridone, phenazine, viologen, alloxazine, isoalloxazine, azobenzene, phthalimide, phenothiazine, naphthalimide, pyromellitic diimide, 1,4,5,8-naphthalenetetracarbodiimide, or benzo(c)cinnoline.

In some embodiments, redox-active species has the formula:

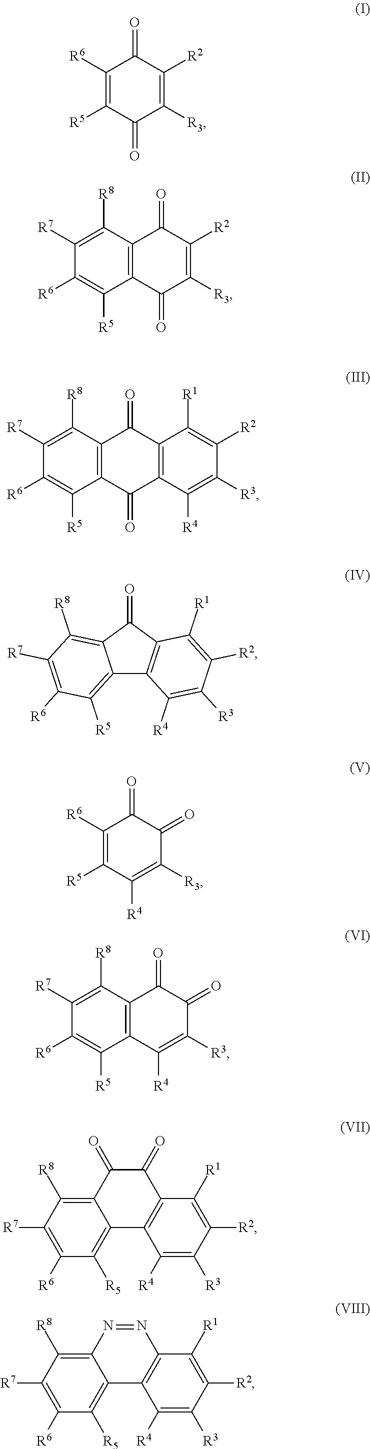

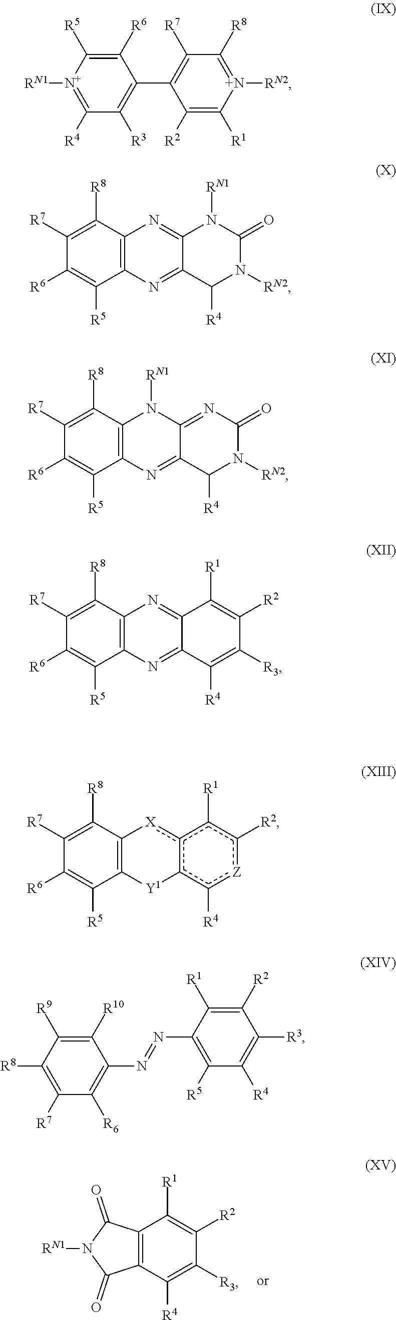

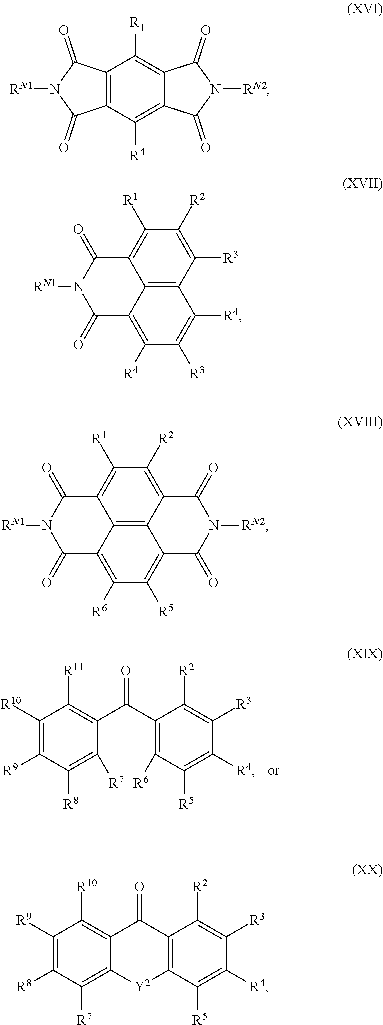

where dashed bonds are single or double bonds;
where X is N or NR^{X}, Y₁ is O or S, Y₂ is C(R⁶)₂, NR^{Y}, S, or O, and Z is CR⁶, C═O, C═S, C═NR^{Z}, or C═NH⁺R^{Z};
where each R^{N1}, R^{N2}, R^{X}, R^{Y}, and R^{Z} is independently selected from —CH₂R^{EWG}; —CH₂R^{QA}; H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; and a nitrogen protecting group;
where each of R¹, R², R³, R⁴, R⁵, R⁶, R⁷, R⁸, R⁹, and R¹⁰ is independently selected from R^{EWG}; R^{QA}; H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; and —P(═O)Rₐ₂; —P(═O)(ORₐ)₂; or any two adjacent groups selected from R¹, R², R³, and R⁴ are joined to form an optionally substituted 3-6 membered ring, or an ion thereof, where each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; and a nitrogen protecting group;
where each R^{EWG} is independently selected from —NO₂, —CN, —SO₃Rₐ, —CHO, —C(═O)Rₐ, —C(═O)O C(═O)Rₐ, —C(═O)ORₐ, (e.g., —C(═O)OH), —CONH₂, —COO⁻, —NRₐ₃⁺, —CF₃, —SO₂Rₐ, —F, —Cl, —Br, —I, —ORₐ, —SRₐ, —P(═O)(ORₐ)₂,—(CH₂)₁₋₃NO₂, —(CH₂)₁₋₃CN, —(CH₂)₁₋₃SO₃Rₐ, —(CH₂)₁₋₃CHO, —(CH₂)_{1- 3}C(═O)Rₐ, —(CH₂)₁₋₃C(═O)OCORₐ, —(CH₂)₁₋₃COORₐ, —(CH₂)₁₋₃C(═O)OH, —(CH₂)₁₋₃CONH₂, —(CH₂)₁₋₃C(═O)O—, —(CH₂)₁₋₃NRₐ₃⁺,—(CH₂)₁₋₃SO₂Rₐ, —CH₂CF₃, —CH₂CCl₃, —CH₂CBr₃, —CH₂C₁₋₃, —CH₂CHF₂, —CH₂CHCl₂, —CH₂CHBr₂, —CH₂CHI₂, —CH₂(CF₂)₁₋₆CF₃,—(CH₂)₁₋₃ORₐ, and —(CH₂)₁₋₃SRₐ, where each Rₐ is independently H; optionally substituted C₁₋₆ alkyl; optionally substituted C₃₋₁₀ carbocyclyl; or optionally substituted C₁₋₉ heterocyclyl having one to four heteroatoms independently selected from O, N, and S;
where each R^{QA} is independently selected from —(CH₂)₁₋₆NRₐ₃⁺, —O(CH₂)₁₋₆NRₐ₃⁺, —S(CH₂)₁₋₆NRₐ₃⁺, —NRₐ(CH₂)₁₋₆NRₐ₃⁺, and —N((CH₂)₁₋₆NRₐ₃⁺)₂, where each Rₐ is independently H; optionally substituted C₁₋₆ alkyl; optionally substituted C₃₋₁₀ carbocyclyl; or optionally substituted C₁₋₉ heterocyclyl having one to four heteroatoms independently selected from O, N, and S;
where at least one of R¹, R², R³, R⁴, R⁵, R⁶, R⁷ and R⁸ is R^{EWG} or R^{QA} and/or at least one R^{N1}, R^{N2}, R^{X}, R^{Y}or R^{Z}, is —CH₂R^{EWG} or —CH₂R^{QA}.

In some embodiments, the redox-active species is:

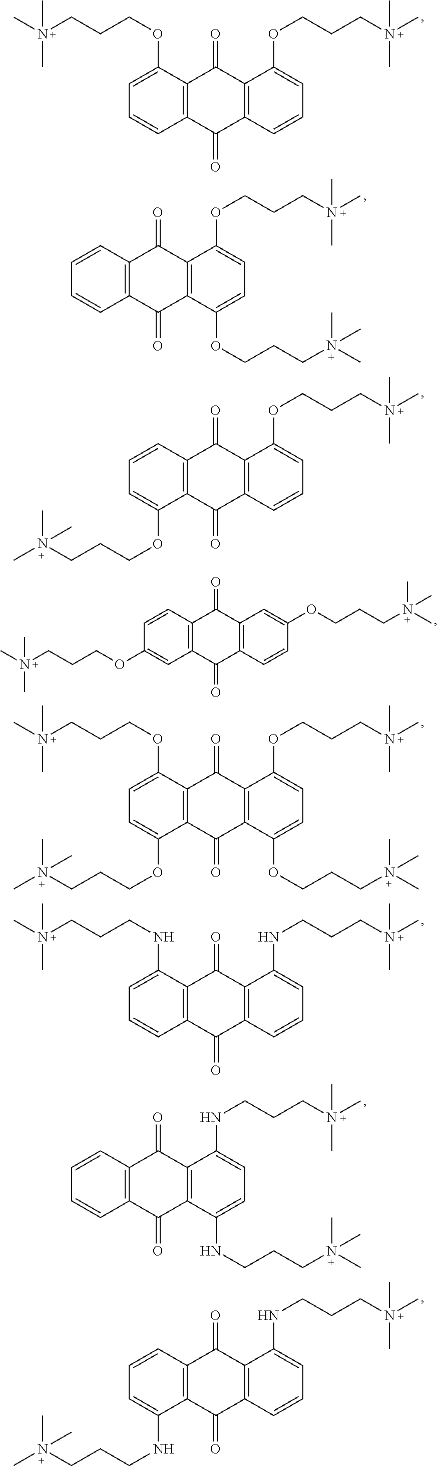

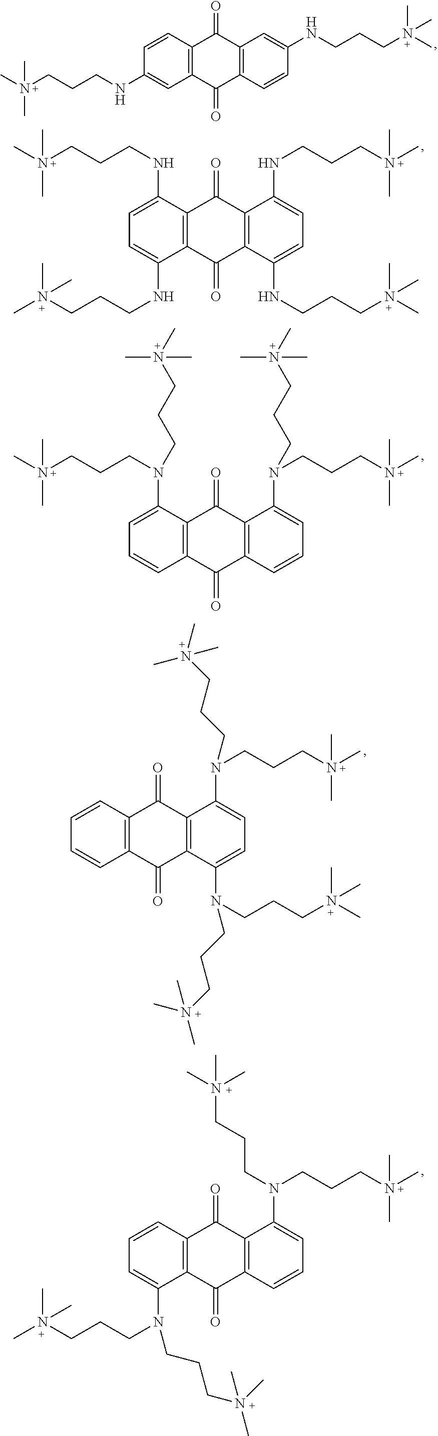

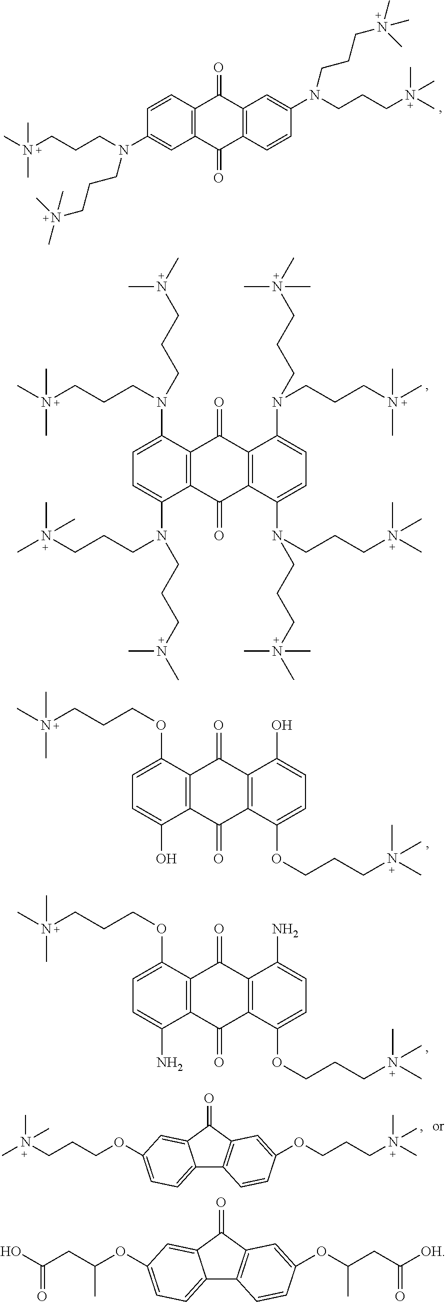

Redox species may also be any salt or ion of these compounds or formulas.

In some embodiments, the electrochemical reduction forms hydroxide ions, and the contacting results in forming inorganic carbonates. In some embodiments, the reduced state reacts with one or more CO₂ molecules to form a CO₂ adduct. In some embodiments, the method includes electrochemically oxidizing the reduced state and/or CO₂ adduct to release CO₂.

In some embodiments, the reduced state reacts with water to produce one or more hydroxide ions. In some embodiments, the method further includes electrochemically oxidizing the reduced state and releasing CO₂.

In some embodiments, the redox-active species is an inorganic redox-active species. In some embodiments, the redox-active species includes a nitrate anion, and the reduced state is a nitrite anion.

In some embodiments, the method further includes electrochemically oxidizing the nitrite anion to a nitrate anion and releasing the CO₂.

In some embodiments, the aqueous solution includes a catalyst or enzyme to reduce an overpotential of reduction of the redox-active species and/or oxidation of the reduced state.

In some embodiments, the catalyst includes Pt, Ir, Pd, Ni, Rh, Ru, Zn, Cu, Fe, or Co, or a combination thereof; or the catalyst includes an aminoxyl radical (e.g., (4-hydroxy-2,2,6,6-tetramethylpiperidin-1-yl)oxyl (TEMPO), 1-hydroxy-2,2,6,6-tetramethylpiperidine (TEMPOH), 4-oxo-2,2,6,6-tetramethyl-1-piperidinyloxy, 4-acetamido-2,2,6,6-tetramethylpiperidine 1-oxyl, 4-carboxy-2,2,6,6-tetramethylpiperidine 1-oxyl, 4-Amino-2,2,6,6-tetramethylpiperidine-1-oxyl, etc.), or a phthalimido-N-oxyl radical (e.g., N-phthalimido-N-oxyl (PINO)). In some embodiments, the enzyme is an alcohol dehydrogenase.

By “about” is meant ±10% of a recited value.

By “alkoxy” is meant a group of formula —OR, where R is an alkyl group, as defined herein.

By “alkyl” is meant straight chain or branched saturated groups from 1 to 6 carbons. Alkyl groups are exemplified by methyl, ethyl, n- and iso-propyl, n-, sec-, iso- and tert-butyl, neopentyl, and the like, and may be optionally substituted with one or more, substituents.

By “alkylene” is meant a divalent alkyl group.

By “alkyl thio” is meant —SR, where R is an alkyl group, as defined herein.

By “alkyl ester” is meant —COOR, where R is an alkyl group, as defined herein.

By “aryl” is meant an aromatic cyclic group in which the ring atoms are all carbon. Exemplary aryl groups include phenyl, naphthyl, and anthracenyl. Aryl groups may be optionally substituted with one or more substituents.

By “carbocyclyl” is meant a non-aromatic cyclic group in which the ring atoms are all carbon. Exemplary carbocyclyl groups include cyclopropyl, cyclobutyl, cyclopentyl, cyclohexyl, cycloheptyl, and cyclooctyl.

Carbocyclyl groups may be optionally substituted with one or more substituents.

By “halo” is meant, fluoro, chloro, bromo, or iodo.

By “hydroxyl” is meant —OH. An exemplary ion of hydroxyl is —O⁻.

By “amino” is meant —NH₂. An exemplary ion of amino is —NH₃+.

By “nitro” is meant —NO₂.

By “carboxyl” is meant —COOH. An exemplary ion of carboxyl is —COO⁻.

By “phosphoryl” is meant —PO₃H₂. Exemplary ions of phosphoryl are —PO₃H⁻ and —PO₃²⁻.

By “phosphonyl” is meant —PO₃R₂, where each R is H or alkyl, provided at least one R is alkyl, as defined herein. An exemplary ion of phosphoryl is —PO₃R⁻.

By “oxo” is meant ═O.

By “sulfonyl” is meant —SO₃H. An exemplary ion of sulfonyl is —SO₃⁻.

By “thiol” is meant —SH.

By “heteroaryl” is meant an aromatic cyclic group in which the ring atoms include at least one carbon and at least one O, N, or S atom, provided that at least three ring atoms are present. Exemplary heteroaryl groups include oxazolyl, isoxazolyl, tetrazolyl, pyridyl, thienyl, furyl, pyrrolyl, imidazolyl, pyrimidinyl, thiazolyl, indolyl, quinolinyl, isoquinolinyl, benzofuryl, benzothienyl, pyrazolyl, pyrazinyl, pyridazinyl, isothiazolyl, benzimidazolyl, benzothiazolyl, benzoxazolyl, oxadiazolyl, thiadiazolyl, and triazolyl.

Heteroaryl groups may be optionally substituted with one or more substituents.

By “heteroalkylene” is meant an alkylene group in which one or more CH₂ units are replaced with one or more heteroatoms selected from O, N, and S. Heteroalkylene can be substituted by oxo (═O). An exemplary heteroalkylene includes an amido group, e.g., —(CH₂)ₙC(O)NH(CH₂)ₘ—, where n and m are independently 1-6.

By “heterocyclyl” is meant a non-aromatic cyclic group in which the ring atoms include at least one carbon and at least one O, N, or S atom, provided that at least three ring atoms are present. Exemplary heterocyclyl groups include epoxide, thiiranyl, aziridinyl, azetidinyl, thietanyl, dioxetanyl, morpholinyl, thiomorpholinyl, piperazinyl, piperidinyl, pyrrolidinyl, tetrahydropyranyl, tetrahydrofuranyl, dihydrofuranyl, tetrahydrothienyl, dihydrothienyl, dihydroindolyl, tetrahydroquinolyl, tetrahydroisoquinolyl, pyranyl, pyrazolinyl, pyrazolidinyl, dihydropyranyl, tetrahydroquinolyl, imidazolinyl, imidazolidinyl, pyrrolinyl, oxazolidinyl, isoxazolidinyl, thiazolidinyl, isothiazolidinyl, dithiazolyl, and 1,3-dioxanyl. Heterocyclyl groups may be optionally substituted with one or more substituents.

By “hydrocarbyl” is meant a branched, unbranched, cyclic, or acyclic group including the elements C and H. Hydrocarbyl groups may be monovalent, e.g., alkyl, or divalent, e.g., alkylene. Hydrocarbyl groups may be substituted with groups including oxo (═O).

By an “oxygen protecting group” is meant those groups intended to protect an oxygen containing (e.g., phenol, hydroxyl, or carbonyl) group against undesirable reactions during synthetic procedures.

Commonly used oxygen protecting groups are disclosed in Greene, “Protective Groups in Organic Synthesis,” 3rd Edition (John Wiley & Sons, New York, 1999), which is incorporated herein by reference. Exemplary oxygen protecting groups include acyl, aryloyl, or carbamyl groups, such as formyl, acetyl, propionyl, pivaloyl, t-butylacetyl, 2-chloroacetyl, 2-bromoacetyl, trifluoroacetyl, trichloroacetyl, phthalyl, o-nitrophenoxyacetyl, α-chlorobutyryl, benzoyl, 4-chlorobenzoyl, 4-bromobenzoyl, t-butyldimethylsilyl, tri-iso-propylsilyloxymethyl, 4,4′-dimethoxytrityl, isobutyryl, phenoxyacetyl, 4-isopropylpehenoxyacetyl, dimethylformamidino, and 4-nitrobenzoyl; alkylcarbonyl groups, such as acyl, acetyl, propionyl, and pivaloyl; optionally substituted arylcarbonyl groups, such as benzoyl; silyl groups, such as trimethylsilyl (TMS), tert-butyldimethylsilyl (TBDMS), tri-iso-propylsilyloxymethyl (TOM), and triisopropylsilyl (TIPS); ether-forming groups with the hydroxyl, such methyl, methoxymethyl, tetrahydropyranyl, benzyl, p-methoxybenzyl, and trityl; alkoxycarbonyls, such as methoxycarbonyl, ethoxycarbonyl, isopropoxycarbonyl, n-isopropoxycarbonyl, n-butyloxycarbonyl, isobutyloxycarbonyl, sec-butyloxycarbonyl, t-butyloxycarbonyl, 2-ethylhexyloxycarbonyl, cyclohexyloxycarbonyl, and methyloxycarbonyl; alkoxyalkoxycarbonyl groups, such as methoxymethoxycarbonyl, ethoxymethoxycarbonyl, 2-methoxyethoxycarbonyl, 2-ethoxyethoxycarbonyl, 2-butoxyethoxycarbonyl, 2-methoxyethoxymethoxycarbonyl, allyloxycarbonyl, propargyloxycarbonyl, 2-butenoxycarbonyl, and 3-methyl-2-butenoxycarbonyl; haloalkoxycarbonyls, such as 2-chloroethoxycarbonyl, 2-chloroethoxycarbonyl, and 2,2,2-trichloroethoxycarbonyl; optionally substituted arylalkoxycarbonyl groups, such as benzyloxycarbonyl, p-methylbenzyloxycarbonyl, p-methoxybenzyloxycarbonyl, p-nitrobenzyloxycarbonyl, 2,4-dinitrobenzyloxycarbonyl, 3,5-dimethylbenzyloxycarbonyl, p-chlorobenzyloxycarbonyl, p-bromobenzyloxy-carbonyl, and fluorenylmethyloxycarbonyl; and optionally substituted aryloxycarbonyl groups, such as phenoxycarbonyl, p-nitrophenoxycarbonyl, o-nitrophenoxycarbonyl, 2,4-dinitrophenoxycarbonyl, p-methyl-phenoxycarbonyl, m-methylphenoxycarbonyl, o-bromophenoxycarbonyl, 3,5-dimethylphenoxycarbonyl, p-chlorophenoxycarbonyl, and 2-chloro-4-nitrophenoxy-carbonyl); substituted alkyl, aryl, and alkaryl ethers (e.g., trityl; methylthiomethyl; methoxymethyl; benzyloxymethyl; siloxymethyl; 2,2,2,-trichloroethoxymethyl; tetrahydropyranyl; tetrahydrofuranyl; ethoxyethyl; 1-[2-(trimethylsilyl)ethoxy]ethyl; 2-trimethylsilylethyl; t-butyl ether; p-chlorophenyl, p-methoxyphenyl, p-nitrophenyl, benzyl, p-methoxybenzyl, and nitrobenzyl); silyl ethers (e.g., trimethylsilyl; triethylsilyl; triisopropylsilyl; dimethylisopropylsilyl; t-butyldimethylsilyl; t-butyldiphenylsilyl; tribenzylsilyl; triphenylsilyl; and diphenymethylsilyl); carbonates (e.g., methyl, methoxymethyl, 9-fluorenylmethyl; ethyl; 2,2,2-trichloroethyl; 2-(trimethylsilyl)ethyl; vinyl, allyl, nitrophenyl; benzyl; methoxybenzyl; 3,4-dimethoxybenzyl; and nitrobenzyl); carbonyl-protecting groups (e.g., acetal and ketal groups, such as dimethyl acetal, and 1,3-dioxolane; acylal groups; and dithiane groups, such as 1,3-dithianes, and 1,3-dithiolane); carboxylic acid-protecting groups (e.g., ester groups, such as methyl ester, benzyl ester, t-butyl ester, and orthoesters; and oxazoline groups.

By a “nitrogen protecting group” is meant those groups intended to protect an amino group against undesirable reactions during synthetic procedures. Commonly used nitrogen protecting groups are disclosed in Greene, “Protective Groups in Organic Synthesis,” 3^{rd} Edition (John Wiley & Sons, New York, 1999), which is incorporated herein by reference. Nitrogen protecting groups include acyl, aryloyl, or carbamyl groups such as formyl, acetyl, propionyl, pivaloyl, t-butylacetyl, 2-chloroacetyl, 2-bromoacetyl, trifluoroacetyl, trichloroacetyl, phthalyl, o-nitrophenoxyacetyl, a-chlorobutyryl, benzoyl, 4-chlorobenzoyl, 4-bromobenzoyl, 4-nitrobenzoyl, and amino acids such as alanine, leucine, and phenylalanine; sulfonyl-containing groups such as benzenesulfonyl, and p-toluenesulfonyl; carbamate forming groups such as benzyloxycarbonyl, p-chlorobenzyloxycarbonyl, p-methoxybenzyloxycarbonyl, p-nitrobenzyloxycarbonyl, 2-nitrobenzyloxycarbonyl, p-bromobenzyloxycarbonyl, 3,4-dimethoxybenzyloxycarbonyl, 3,5-dimethoxybenzyloxycarbonyl, 2,4-dimethoxybenzyloxycarbonyl, 4-methoxybenzyloxycarbonyl, 2-nitro-4,5-dimethoxybenzyloxycarbonyl, 3,4,5-trimethoxybenzyloxycarbonyl, 1-(p-biphenylyl)-1-methylethoxycarbonyl, α,α-dimethyl-3,5-dimethoxybenzyloxycarbonyl, benzhydryloxy carbonyl, t-butyloxycarbonyl, diisopropylmethoxycarbonyl, isopropyloxycarbonyl, ethoxycarbonyl, methoxycarbonyl, allyloxycarbonyl, 2,2,2,-trichloroethoxycarbonyl, phenoxycarbonyl, 4-nitrophenoxy carbonyl, fluorenyl-9-methoxycarbonyl, cyclopentyloxycarbonyl, adamantyloxycarbonyl, cyclohexyloxycarbonyl, and phenylthiocarbonyl, alkaryl groups such as benzyl, triphenylmethyl, and benzyloxymethyl, and silyl groups, such as trimethylsilyl. Preferred nitrogen protecting groups are alloc, formyl, acetyl, benzoyl, pivaloyl, t-butylacetyl, alanyl, phenylsulfonyl, benzyl, t-butyloxycarbonyl (Boc), and benzyloxycarbonyl (Cbz).

For the purposes of this invention, the term “quinone” includes a compound having one or more conjugated, C₃₋₁₀ carbocyclic, fused rings, substituted, in oxidized form, with two or more oxo groups, which are in conjugation with the one or more conjugated rings. Preferably, the number of rings is from one to ten, e.g., one, two, or three, and each ring has 6 members.

As noted, substituents may be optionally substituted with halo, optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ; —N(Rₐ)₂; —C(═O)Rₐ; —C(═O)ORₐ; —S(═O)₂Rₐ; —S(═O)₂ORₐ; —P(═O)Rₐ₂; —O—P(═O)(ORₐ)₂, or —P(═O)(ORₐ)₂, or an ion thereof; where each Rₐ is independently H, C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. Cyclic substituents may also be substituted with optionally substituted C₁₋₆ alkyl. In specific embodiments, substituents may include optionally substituted with halo, optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —NO₂; —ORₐ; —N(Rₐ)₂; —C(═O)Rₐ; —C(═O)ORₐ; —S(═O)₂Rₐ; —S(═O)₂ORₐ; —P(═O)Rₐ₂; —O—P(═O)(ORₐ)₂, or —P(═O)(ORₐ)₂, or an ion thereof; where each Rₐ is independently H, C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group, and cyclic substituents may also be substituted with C₁₋₆ alkyl. In specific embodiments, alkyl groups may be optionally substituted with one, two, three, or, in the case of alkyl groups of two carbons or more, four substituents independently selected from the group consisting of halo, hydroxyl, C₁₋₆ alkoxy, SO₃H, amino, nitro, carboxyl, phosphoryl, phosphonyl, thiol, C₁₋₆ alkyl ester, optionally substituted C₁₋₆ alkyl thio, and oxo, or an ion thereof. Substituents may also be selected from the electron withdrawing groups described herein.

Exemplary ions of substituent groups are as follows: an exemplary ion of hydroxyl is —O—; an exemplary ion of —COOH is —COO⁻; exemplary ions of —PO₃H₂ are —PO₃H⁻ and —PO₃₂—; an exemplary ion of —PO₃HRₐ is —PO₃Rₐ⁻, where Rₐ is not H; exemplary ions of —PO₄H₂ are —PO₄H⁻ and —PO₄²⁻; an exemplary ion of —SO₃H is —SO₃⁻; and an exemplary ion of NRa₂ is NRa₂H⁺.

### BRIEF DESCRIPTION OF THE DRAWINGS

FIG. 1. Process schematic for CO₂ capture/release via the pH swing (black equations) and the nucleophilicity swing (blue equations) mechanism. Processes between numbered states are electrochemical oxidation for reduced RO (1→2), CO₂ outgassing (2→3), electrochemical reduction of RO (3→4), CO₂ invasion (4→1).

FIG. 2. Electrochemical redox reactions involved during the CO₂ capture/release processes. Processes illustrated with an anthraquinone (AQ) core. AQ can be reversibly reduced to anthraquinone dianion (AQ²⁻) via two-electron transfer. AQ²⁻ can react with two CO₂ molecules and form an adduct of organic carbonate: AQ(CO₂)₂²⁻. In addition, depending on the pKa values of anthrahydroquinone (AQH₂), AQ²⁻ can react with water to become half-protonated (AQH⁻) or fully protonated (AQH₂) as well as produce hydroxyl anions, which can react with CO₂ to form the inorganic (bi)carbonate.

FIG. 3. O₂-induced side reactions of reduced AQ species include: AQ(CO₂)₂²⁻ can be oxidized by oxygen to AQ. AQ²⁻, AQH⁻, and AQH₂ can also be oxidized by oxygen to AQ.

FIG. 4. Stability in air of reduced 1,8-BTMAPAQ with captured CO₂ tracked by ¹H NMR. From day 1 to day 9, the NMR sample was loosely capped for intentional air exposure. The peaks of oxidized state of 1,8-BTMAPAQ appear on day-9.

FIG. 5. Stability in air of the reduced 1,4-BTMAPAQ tracked by ¹H NMR. From day 1 to day 6, the NMR sample was loosely capped for intentional air exposure. The peaks of oxidized state of 1,4-BTMAPAQ start to appear on day 3; 11.3%, 27.6%, and 50% of reduced 1,4-BTMAPAQ converted to the oxidized form on day-3, day-4, and day-6.

FIG. 6. Stability in air of the reduced 1,4-BTMAPAQ with capture CO₂ tracked by ¹H NMR. From day 1 to day 6, the NMR sample was loosely capped for intentional air exposure. The peaks of oxidized state of 1,4-BTMAPAQ start to appear on day 2; 51.5%, 73.0%, and 98.0% of reduced 1,4-BTMAPAQ with captured CO₂ converted to the oxidized form on day-3, day-4, and day-6.

FIG. 7. Stability in air of the reduced 1,5-BTMAPAQ tracked by ¹H NMR. From day 1 to day 5, the NMR sample was loosely capped for intentional air exposure. The peaks of oxidized state of 1,5-BTMAPAQ start to appear on day 2; 23.6%, 37.0%, 47.4% of reduced 1,5-BTMAPAQ converted to the oxidized form on day-2, day-3, day-5.

FIG. 8. Stability in air of the reduced 1,5-BTMAPAQ with captured CO₂ tracked by ¹H NMR. From day 1 to day 6, the NMR sample was loosely capped for intentional air exposure. The peaks of oxidized state of 1,5-BTMAPAQ start to appear on day 4; 15.0%, 22.3% of reduced 1,5-BTMAPAQ with captured CO₂ converted to the oxidized form on day-4 and day-6.

FIG. 9. Cyclic voltammetry was used to examine the electrochemical behaviors of the water-soluble redox molecules in the presence/absence of CO₂. 0.1 M 1,8-BTMAPAQ in 1 M TBABr demonstrates a pair of symmetric redox peaks with a peak separation of 100 mV. In the presence of CO₂, the solution exhibits a broad anodic large peak and a peak separation of 200 mV. scan rate: 100 mV/s.

FIG. 10. Stability in air of the reduced 2,7-BTMAPFL at pH 7 tracked by ¹H NMR. From bottom to top: pristine 2,7-BTMAPFL (oxidized form) at pH 7; pristine 2,7-BTMAPFL-OH (reduced form) at pH 7; and 2,7-BTMAPFL-OH at pH 7 stirred in air for 12 hours at room temperature.

FIG. 11. Stability in air of the reduced 2,7-BTMAPFL at pH 14 tracked by ¹H NMR. From bottom to top: pristine 2,7-BTMAPFL (oxidized form) at pH 14; pristine 2,7-BTMAPFL-OH (reduced form) at pH 14; and 2,7-BTMAPFL-OH at pH 14 stirred in air for 12 hours at room temperature.

FIG. 12. Cyclic voltammetry was used to examine the electrochemical behaviors of the water-soluble redox molecule 2,7-BTMAPFL. 0.1 M 2,7-BTMAPFL in 1 M KCl at pH 7 demonstrates a reduction peak but no oxidation peak. 0.1 M 2,7-BTMAPFL in 1 M KOH at pH 14 demonstrates a pair of redox peaks at −0.67 V vs. Ag/AgCl. scan rate: 100 mV/s.

### DETAILED DESCRIPTION OF THE INVENTION

The invention provides electrochemically cycled methods of capturing CO₂, e.g., from air or flue gas, and releasing pure CO₂, using water-soluble oxygen-resistant redox-active species circulated in flow cells.

The method is safe, scalable, and potentially inexpensive, as it utilizes non-volatile and potentially low-cost redox organic and inexpensive inorganic species, can operate at ambient temperature and pressure, and can operate at high current densities.

The capture method involves either a pH-swing cycle or a nucleophilicity-swing cycle of dissolved redox-active species, electrochemically driven through the proton-coupled electron transfer (PCET) or CO₂-coupled electron transfer. In pH-swing cycle capture, redox organics (RO, e.g., an anthraquinone) or redox inorganics (RI, e.g., a nitrate salt) react with water, e.g., to become, e.g., ROH₂ (e.g., an anthrahydroquinone), or, e.g., RIⁿ⁻ (e.g., a nitrite salt), during the electrochemical reduction and produce hydroxides which react with CO₂ and form inorganic (bi)carbonates (e.g., HCO₃⁻, CO₃²⁻). In nucleophilicity-swing capture, ROs become nucleophiles after reduction which can react with CO₂ directly to form organic carbonates (e.g., RO(CO₂)₂²⁻, e.g., where RO is a quinone, e.g., an anthraquinone, core).

During the electrochemical oxidation, ROs can release protons that react with inorganic (bi)carbonates and release CO₂; or ROs lose affinity for CO₂ and release pure CO₂. During the electrochemical oxidation, reduced RIs such as the nitrate/nitrite redox couple can consume hydroxide ions thereby lowering the pH and allowing release of CO₂.

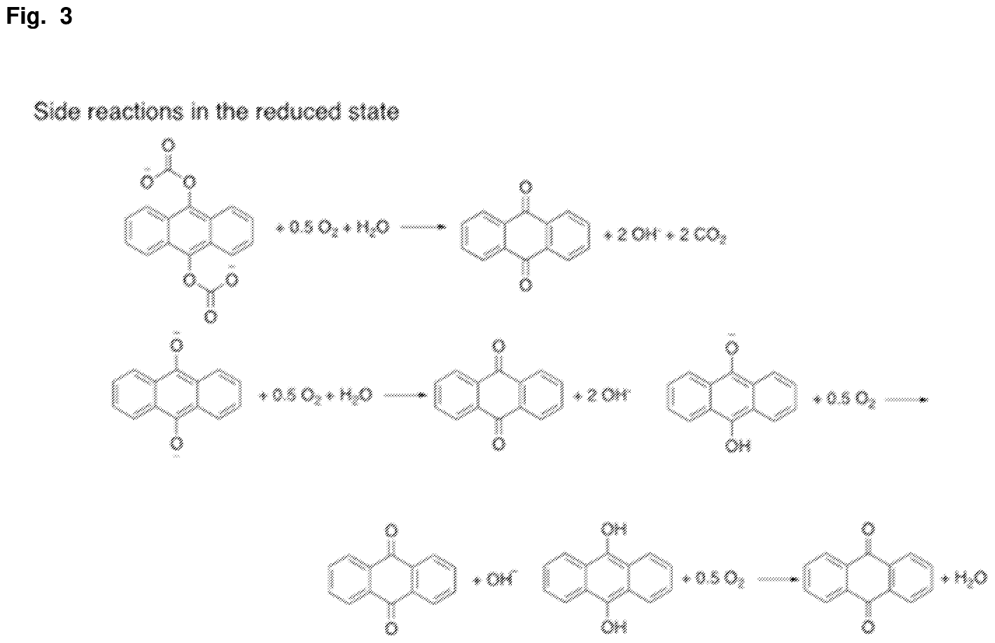

In both mechanisms of capture involving ROs, a reduced state of ROs is required for CO₂ capture. However, reduced ROs are oxygen sensitive, and atmospheric O₂ can chemically oxidize reduced ROs back to the oxidized state of ROs, which do not have CO₂ affinity (FIG. 3). Therefore, the instability of reduced ROs in air has prevented its application to direct air capture (DAC) or CO₂ capture from flue gas until now. Our newly designed ROs have functional groups that make them air-stable in their reduced states. Our ROs exhibit good air stability over several days, allowing use in DAC or CO₂ capture from flue gas where it would undergo multiple oxidation/reduction cycles per day.

### Redox Organics

In this invention, we enhance air-stability of reduced ROs through inclusion of one or multiple functional groups on the redox cores. The functional group may be attached to the redox core at any possible position, e.g., any position that would otherwise be occupied by H. The introduced functional groups could be the same, or different. Redox cores include, but are not limited to, para or ortho benzoquinone, naphthoquinone, anthraquinone, phenanthrenequinone, fluorenone, benzophenone, anthrone, xanthone, thioxanthone, acridone, phenazine, viologen, alloxazine, isoalloxazine, azobenzene, phthalimide, phenothiazine, naphthalimide, pyromellitic diimide, 1,4,5,8-naphthalenetetracarbodiimide, or benzo(c)cinnoline. Specific formulas are provided in formulas (I)—(XX). Redox organics may be present in a mixture.

Organic redox-active species may include multiple electron-withdrawing groups to elevate redox potentials to be comparable to or higher than the 02 reduction potential at the pH of interest, so that the oxidation of the reduced molecules by 02 is thermodynamically less favored, or even disfavored. The electron-withdrawing groups can be directly connected to the redox cores, or indirectly connected to the redox cores via C, N, O, S atoms, with zero or multiple, e.g., one, two, three, etc., methylene spacing groups.

Alternatively, or in addition, redox-active organic species of the invention may include groups which frustrate the oxygenation of the reduced state kinetically, e.g., by intramolecular and/or intermolecular non-covalent interactions including hydrogen bonding, zwitterionic interactions, and Lewis acid and base pair interactions to frustrate. The intramolecular non-covalent interactions may be introduced by covalently attaching functional groups to the redox cores. The intermolecular non-covalent interactions may be inter- or intramolecular interactions of functionalized redox molecules or may be provided by introducing additives into electrolytes (e.g., counterions to the negative charges on the reduced state which kinetically frustrate the reaction with oxygen). The additives could be bulky salts, including but not limited to tetraalkyl ammonium salts, such as tetramethyl ammonium, tetraethyl ammonium, tetrapropyl ammonium, tetrabutyl ammonium cations, etc. Corresponding anions before additive cations may include chloride, bromide, iodide, etc.

Exemplary electron withdrawing groups include —NO₂, —CN, —SO₃Rₐ, —CHO, —C(═O)Rₐ, —C(═O)O C(═O)Rₐ, —C(═O)ORₐ, (e.g., —C(═O)OH), —CONH₂, —COO⁻, —NRₐ₃⁺, —CF₃, —SO₂Rₐ, —F, —Cl, —Br, —I, —ORₐ, —SRₐ, —P(═O)(ORₐ)₂,—(CH₂)₁₋₃NO₂, —(CH₂)₁₋₃CN, —(CH₂)₁₋₃SO₃Rₐ, —(CH₂)₁₋₃CHO, —(CH₂)₁₋₃C(═O)Rₐ, —(CH₂)₁₋₃C(═O)OCORₐ, —(CH₂)₁₋₃COORₐ, —(CH₂)₁₋₃C(═O)OH, —(CH₂)₁₋₃CONH₂, —(CH₂)₁₋₃C(═O)O—, —(CH₂)₁₋₃NRₐ₃⁺,—(CH₂)₁₋₃SO₂Rₐ, —CH₂CF₃, —CH₂CCl₃, —CH₂CBr₃, —CH₂Cl₃, —CH₂CHF₂, —CH₂CHCl₂, —CH₂CHBr₂, —CH₂CHI₂, —CH₂(CF₂)₁₋₆CF₃,—(CH₂)₁₋₃ORₐ, and —(CH₂)₁₋₃SRₐ, where each Rₐ is independently H; optionally substituted C₁₋₆ alkyl; optionally substituted C₃₋₁₀ carbocyclyl; or optionally substituted C₁₋₉ heterocyclyl having one to four heteroatoms independently selected from O, N, and S, e.g., —SO₃H, —PO₃H₂, —COOH, —OH, —NH₂, —N(CH₃)₃⁺, —NH₃⁺, and ethyleneglycol (—OCH₂CH₂OCH₂CH₂OH).

In some embodiments, the substituents are optionally substituted C₁₋₆ alkyl groups including a quaternary ammonium group, optionally substituted C₁₋₆ alkoxy groups including a quaternary ammonium group, optionally substituted C₁₋₆ alkyl thio groups including a quaternary ammonium group. In some embodiments, the quaternary amine group is attached to a terminal carbon. In some embodiments, the one or more substituents include at least one —(CH₂)ₙNRₐ₃⁺ group, where n=2-11, where each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; or a nitrogen protecting group.

In some embodiments, the redox-active species is:

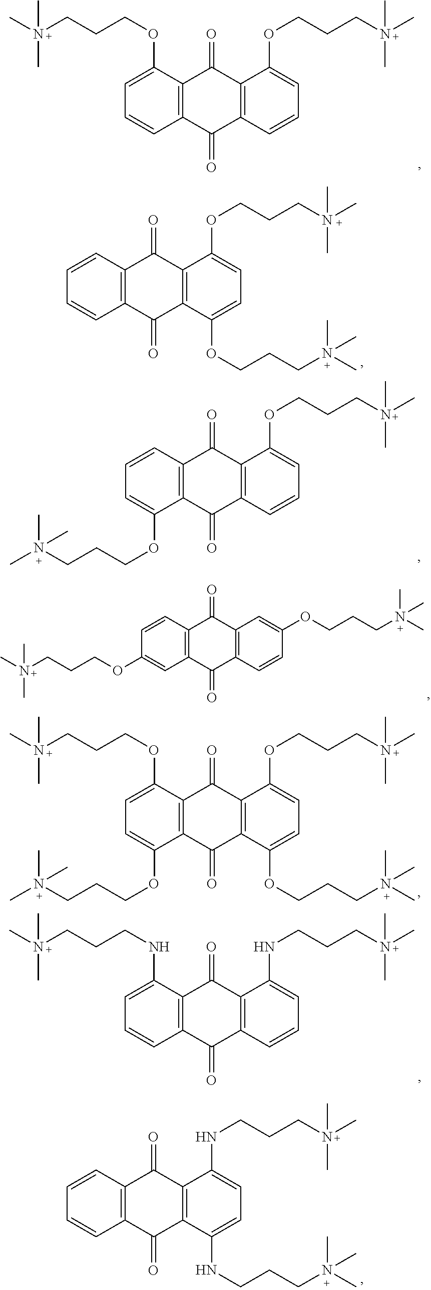

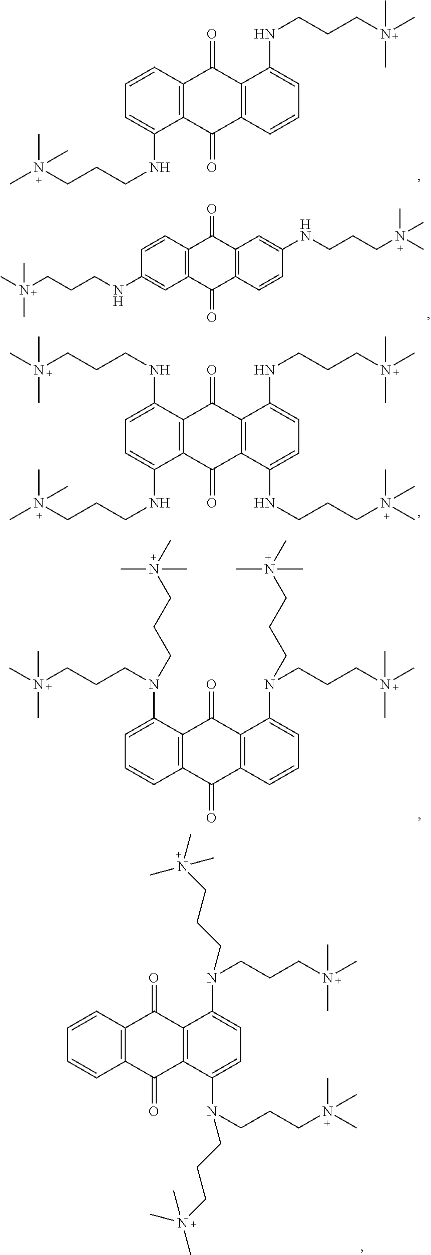

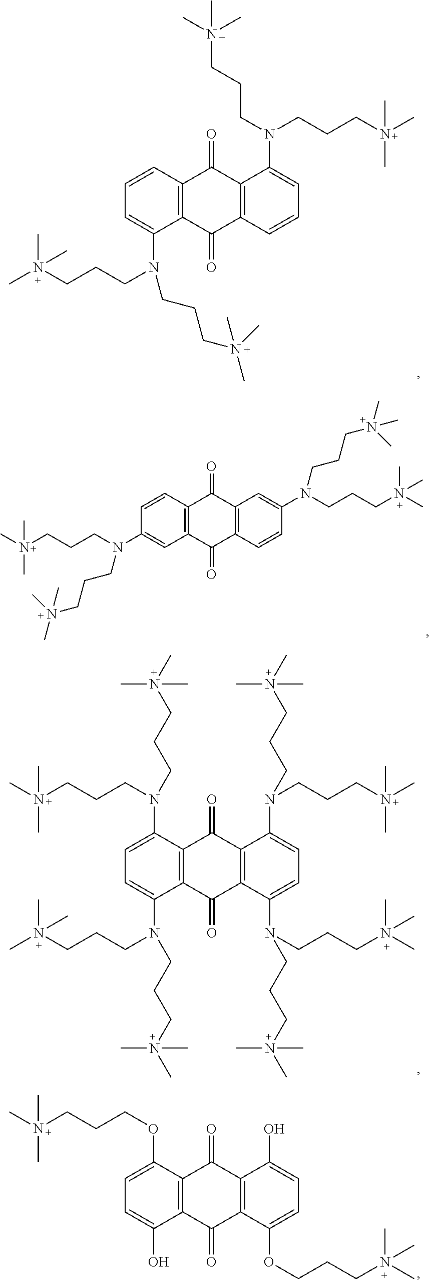

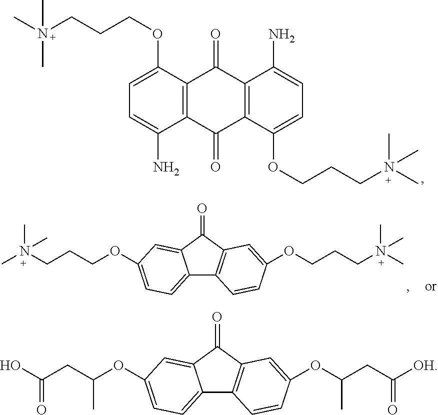

An example is bis-(trimethylammonio)propyl anthraquinone (BTMAPAQ)-based isomers. Our results indicate that the reduced states of BTMAPAQ isomers (with and without captured CO₂) show excellent air-resistance, which is the key to be utilized for CO₂ capture in air or flue gas. In some embodiments, the redox-active species is not a BTMAPAQ, e.g., is not 1,8-BTMAPAQ.

In some embodiments, at least 10%, e.g., at least 20, 30, 40, 50, 60, 70, 80, 90, 95, or 99%, of the reduced state is present after exposure to air for at least one day, e.g., at least 2, 3, 4, 5, 6, or 7 days or at least 1, 2, 3, or 4 weeks, or at least 1, 2, 3, 4, 5, or 6 months, e.g., the redox species is stable up to 6 months or one year.

### Redox Inorganics

Inorganic redox-active species such as the nitrate (NO₃⁻)/nitrite (NO₂⁻) redox pair can be used to conduct PCET reaction. For example, the reduction of nitrate generates nitrite and hydroxide, increasing the solution pH:

NO₃⁻+H₂O+2e⁻→NO₂⁻+20H⁻

and the oxidation of nitrite generates nitrate and consumes hydroxide, decreasing the pH:

NO₂⁻⁺²⁰H⁻→NO₃⁻+H₂O+2e⁻

Hence, the solution pH is reversibly tuned, which is followed by reversible CO₂ capture/release. The redox potential of the pair is 0.94 V vs. RHE (S. Bratsch, J. Phys. Chem. Ref. Data 1989, 18, 1). This redox potential is higher than most ROs, whose redox potentials are usually around ˜0-0.2 V. vs RHE depends on the pH. As a result, the reduced form of the nitrate/nitrite pair, i.e., NO₂⁻, is much more air-stable compared to the reduced form of ROs. The superior air-stability of NO₂ at pH >6 is known (W. Braida et al., Water, Air and Soil Pollution 2000, 118, 13-26). Besides the air stability, the high solubility of nitrate and nitrite salts (>10 M) and their low price ($400-600/MT or $0.5-1/KAh, about two orders of magnitude smaller than the lower end of RO price, i.e., $84) makes the redox pair advantageous for DAC and flue gas capture. The high overpotential of the nitrate reduction and nitrite oxidation processes can be mediated with metal-based catalysts, enzymes or modified electrodes (Z. Mumtarin et al., Electrochimica Acta 2020, 346, 135994; G. Mersal et al., Int. J. Electrochem. Sci. 2011, 6, 761-777; J. Craig et al., J. Am. Chem. Soc. 1989, 111, 2111-2115; J. Jiang et al., Inorg. Chem. 2005, 44, 1068-10725. F. Armijo et al., Journal of Molecular Catalysis A; Chemical 2007, 148-154; A. Chamsi et al., Analyst 1988, 133, 1723-1727). The long-term stability of nitrite, which suffers from possible disproportionation reaction if nitrite is protonated:

3HNO₂→HNO₃+2NO(g)+H₂O

is handled by carefully maintaining the pH at above 5.3, where >99% of nitrite molecules are deprotonated, and by keeping a high concentration of NO₃⁻ (W. Braida et al., Water, Air and Soil Pollution 2000, 118, 13-26).

### Capture Devices

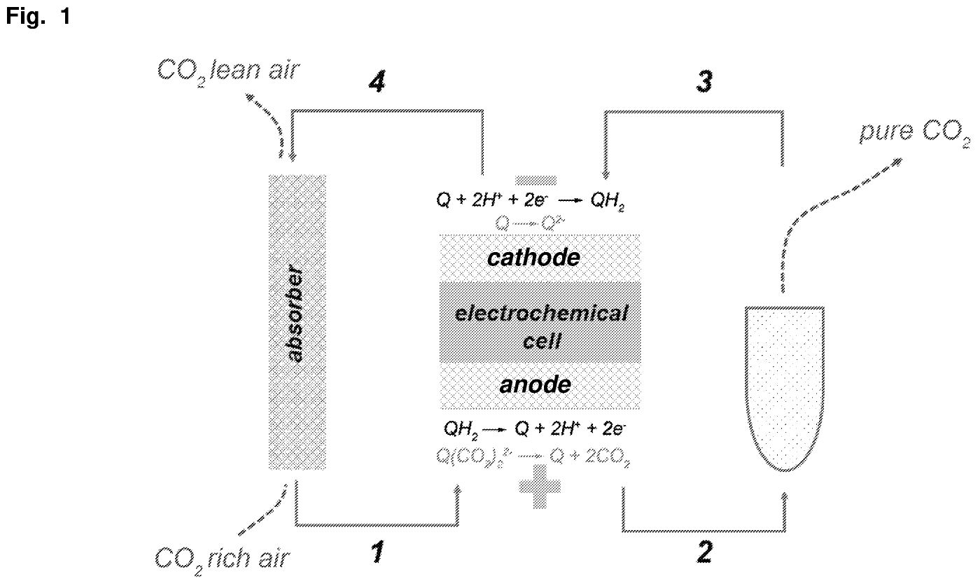

Capture devices may include a negolyte (negative electrolyte) that includes, e.g., a RO or RI dissolved or suspended in aqueous solution; a posolyte (positive electrolyte) that includes, e.g., a redox-active species; and a barrier separating the two. The redox-active species in negolyte and posolyte could be either the same molecule or different molecules. The device further includes at least two electrodes, one in contract with the negolyte and one in contact with the posolyte. The electrodes may be carbon-based materials, pure metals, or alloys. Electrodes may be doped or decorated with catalysts. FIG. 1 provides a device configured to capture and then release CO₂, e.g., from either flue gas or air. Gas containing CO₂ contacts the negolyte containing a proton-coupled redox-active species at a high pH or a nucleophilic reduced redox-active species. This region also includes a gas outlet to allow the carrier source gas, e.g., flue gas or air, to exit the device after being depleted of CO₂. Nitrogen or other inert gas may be used to purge the negolyte of dissolved gases, e.g., oxygen or CO₂. The outlet may be connected to a storage container for CO₂.

During invasion, the high-pH liquid may be sprayed down through a solid lattice, providing a liquid/gas interface for CO₂ in the gas to enter the liquid. A similar lattice may be employed when CO₂ gas is released from the liquid.

The devices may also employ redox species having an aminoxyl radical group, e.g., 2,2,6,6-tetramethylpiperidine-N-oxyl (TEMPO) or substituted versions thereof (e.g., substituted like a heterocycle as described herein). Devices may also include aminoxyl radical species as catalysts/charge mediators, e.g., compounds such as (4-hydroxy-2,2,6,6-tetramethylpiperidin-1-yl)oxyl (TEMPO), 1-hydroxy-2,2,6,6-tetramethylpiperidine (TEMPOH), 4-oxo-2,2,6,6-tetramethyl-1-piperidinyloxy, 4-acetamido-2,2,6,6-tetramethylpiperidine 1-oxyl, 4-carboxy-2,2,6,6-tetramethylpiperidine 1-oxyl, 4-Amino-2,2,6,6-tetramethylpiperidine-1-oxyl, etc.). Compounds having a phthalimido-N-oxyl radical group (e.g., N-phthalimido-N-oxyl (PINO)) may also be used. Such species may be employed to capture CO₂ on the positive or negative side of the device.

Examples of redox-active species for the posolyte include bromine, chlorine, iodine, vanadium, chromium, cobalt, iron (e.g., ferricyanide/ferrocyanide or a ferrocene derivative, e.g., as described in WO 2018/032003), aluminum, e.g., aluminum(III) biscitrate monocatecholate, manganese, cobalt, nickel, copper, or lead, e.g., a manganese oxide, a cobalt oxide, or a lead oxide. A benzoquinone may also be used as the second redox-active species. Other redox-active species suitable for use in batteries of the invention are described in WO 2014/052682, WO 2015/048550, WO 2016/144909, and WO 2020/072406, the redox-active species of which are incorporated by reference. The redox-active species may be dissolved or suspended in solution (such as aqueous solution) or be in the solid state.

Posolyte and negolyte may include the same redox species but with the opposite states, e.g., one is the reduced state, and the other one is the oxidized state. One side is to capture CO₂, e.g., from flue gas or air, and the other side is to release CO₂.

In some embodiments, the electrolytes are both aqueous, where the negolyte and posolyte are aqueous.

In addition, the electrolyte may include other solutes, e.g., acids (e.g., HCl) or bases (e.g., LiOH, NH₄OH, NaOH, or KOH) or alcohols (e.g., methyl, ethyl, or propyl) and other co-solvents to increase the solubility of a particular species, e.g., quinone/hydroquinone. Counter ions, such as cations, e.g., NH₄⁺, Li⁺, Na⁺, K⁺, or a mixture thereof, may also be present. In certain embodiments, the pH of one or both of the electrolytes may be >7, e.g., at least 8, 9, 10, 11, 12, 13, or 14, 8-14, 9-14, 10-14, 11-14, 12-14, 13-14, or about 14. In certain embodiments, the pH of one or both of the electrolytes may be <7, e.g., at less than 7, 6, 5, 4, 3, 2, or 1, e.g., 7-1, 7-5, 6-4, 5-2, 3-1, 2-1, or about 1. The pH may be less than 1. The pH may be a negative pH. The electrolyte may or may not be buffered to maintain a specified pH. In methods and systems using nitrite ions, the pH may be modulated to remain above pH 7 to prevent unwanted side reactions of the protonated nitrite ion. The concentration of the negolyte and posolyte will be suitable to operate the device, e.g., battery or carbon capture device, for example, from 0.1-15 M, or from 0.1-10 M. In some embodiments, the solution is at least 10%, 20%, 30%, 40%, 50%, 60%, 70%, or 80% water, by mass. The electrolytes may contain one or more redox-active species (e.g., ROs or RIs) that act as redox mediators.

In addition to water, solutions or suspensions may include alcohols (e.g., methyl, ethyl, or propyl) and other co-solvents to increase the solubility of a particular species. In some embodiments, the solution or suspension is at least 10%, 20%, 30%, 40%, 50%, 60%, 70%, or 80% water, by mass. Alcohol or other co-solvents may be present in an amount required to result in a particular concentration of species. The pH of the aqueous solution or suspension may also be adjusted by addition of acid or base, e.g., to aid in solubilizing a species.

The barrier allows the passage of ions, such as sodium or potassium, but not a significant amount of the redox-active species. Examples of ion conducting barriers are NAFION®, i.e., sulfonated tetrafluoroethylene based fluoropolymer-copolymer, FUMASEP®, i.e., non-fluorinated, sulfonated polyaryletherketone-copolymer, e.g., FUMASEP® E-620(K), hydrocarbons, e.g., polyethylene, and size exclusion barriers, e.g., ultrafiltration or dialysis membranes with a molecular weight cut off of 100, 250, 500, or 1,000 Da. Examples of membranes include Selemion DSV and Selemion AMV. For size exclusion membranes, the required molecular weight cut off is determined based on the molecular weight of the negolytes and posolytes employed. Porous physical barriers may also be included, e.g., when the passage of redox-active species is tolerable. A redox flow cell may have two barriers and a central compartment disposed therebetween.

Electrodes for use with batteries and CO₂ capture devices may include any carbon electrode, e.g., glassy carbon electrodes, carbon paper electrodes, carbon felt electrodes, or carbon nanotube electrodes. Titanium electrodes may also be employed. Electrodes can also be made of a high specific surface area conducting material, such as a nanoporous metal sponge (T. Wada, A. D. Setyawan, K. Yubuta, and H. Kato, Scripta Materialia 65, 532 (2011)), which has been synthesized previously by electrochemical dealloying (J. D. Erlebacher, M. J. Aziz, A. Karma, N. Dmitrov, and K. Sieradzki, Nature 410, 450 (2001)), or a conducting metal oxide, which has been synthesized by wet chemical methods (B. T. Huskinson, J. S. Rugolo, S. K. Mondal, and M. J. Aziz, arXiv:1206.2883 [cond-mat.mtrl-sci]; Energy & Environmental Science 5, 8690 (2012); S. K. Mondal, J. S. Rugolo, and M. J. Aziz, Mater. Res. Soc. Symp. Proc. 1311, GG10.9 (2010)). Chemical vapor deposition can be used for conformal coatings of complex 3D electrode geometries by ultra-thin electrocatalyst or protective films. Other electrodes are known in the art.

A carbon capture device may include additional components as is known in the art. Negolytes and posolytes may be housed in a suitable reservoir. A carbon capture device may further include one or more pumps to pump aqueous solutions or suspensions past one or both electrodes. Alternatively, the electrodes may be placed in a reservoir that is stirred or in which the solution or suspension is recirculated by any other method, e.g., convection, sonication, etc. A carbon capture device may also include graphite flow plates and corrosion-resistant metal current collectors.

The balance of the system around the cell includes fluid handling and storage, and voltage and round-trip energy efficiency measurements can be made. Systems configured for measurement of negolyte and posolyte flows and pH, pressure, temperature, current density and cell voltage may be included and used to evaluate cells, e.g., to determine when to apply the electrical pulse. Fluid sample ports can be provided to permit sampling of both electrolytes, which will allow for the evaluation of parasitic losses due to reactant crossover or side reactions. Electrolytes can be sampled and analyzed with standard techniques.

Suitable cells, electrodes, membranes, and pumps for redox flow batteries are known in the art, e.g., WO 2014/052682, WO 2015/048550, WO 2016/144909, and WO 2020/072406, the battery components of which are hereby incorporated by reference.

### Methods

Solutions of oxygen-resistant redox-active species are used to capture CO₂, e.g., from air or flue gas and release pure CO₂.

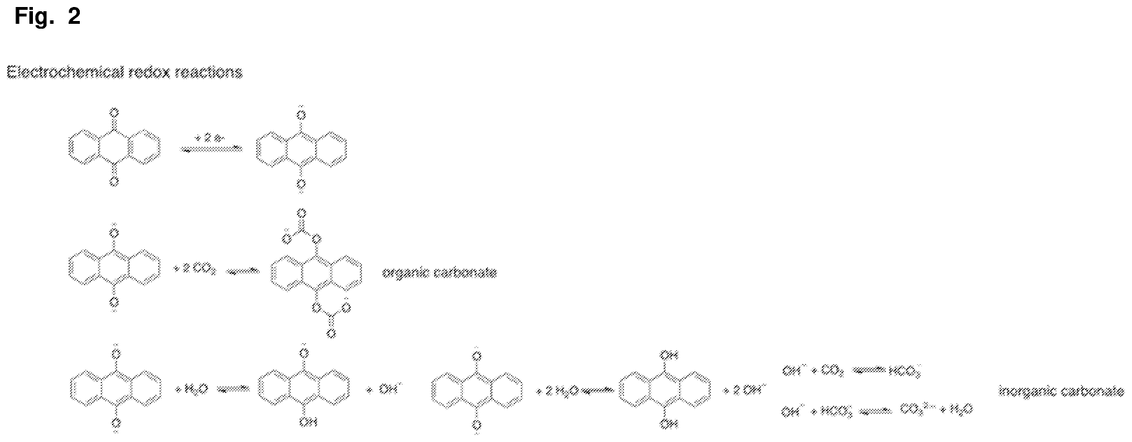

The methods include providing an electrochemical cell including a redox-active species dissolved or dispersed in aqueous solution. The redox-active species is electrochemically reduced to a reduced state. The reduced state is then contacted with a mixture of gases including CO₂, e.g., by bubbling air or flue gas through an aqueous solution. Air is present in the mixture of gases, which would typically oxidize a reduced state of the redox-active species back to the oxidized state, but these undesired reactions are prevented or slowed using redox-active species that are resistant to oxidation in their reduced states. The reduction of the redox-active species may generate hydroxide ions which react with CO₂ to form inorganic carbonates (PCET), and/or the reduced state may itself react (e.g., by a nucleophilic addition reaction) with CO₂ to form a CO₂ adduct (FIG. 2). Both the inorganic carbonates and CO₂ adducts may be disproportionated to release CO₂ by exposing the solution to an oxidizing electrochemical potential, while also regenerating the redox-active species for further capture cycles.

FIG. 1 shows a process schematic for applying methods of the invention to capture and release CO₂ via the pH swing (black equations) and the nucleophilicity swing (blue equations) mechanism. “Q” refers to a PCET organic or inorganic species. Processes between numbered states are electrochemical oxidation for reduced RO or RI (1→2), CO₂ outgassing (2→3), electrochemical reduction of RO or RI (3→4), CO₂ invasion (4→1).

The invention can be used for an electrochemical CO₂ capture system, e.g., employing proton-coupled redox-active species whose protonation and deprotonation can be controlled electrochemically to modify the pH of an aqueous solution or aqueous suspension. This change in pH can be used to sequester and release CO₂. The CO₂ capture device can be used to sequester gaseous CO₂ from a point source, such as flue gas, or from ambient air. The total possible amount of sequestered carbon, the Dissolved Inorganic Carbon (DIC), depends on the partial pressure of CO₂ above the aqueous solution or aqueous suspension, and the pH determines the form of the carbon, e.g., dissolved CO₂, HCO₃— or CO₃²⁻. CO₂ can be captured from a gaseous source, e.g., point sources or ambient air, by dissolving into an aqueous solution. More CO₂ can be dissolved as the pH of the aqueous solution or aqueous suspension increases, resulting in the conversion of CO₂ into HCO₃⁻ or CO₃²⁻ ions. More CO₂ can be dissolved in an aqueous solution or aqueous suspension as HCO₃ or CO₃²⁻ than CO₂, resulting in supersaturation of CO₂ in the aqueous solution or aqueous suspension. Once captured, the CO₂ can be released by acidifying the aqueous solution or aqueous suspension, e.g., by electrochemical oxidation. Alternatively, the reduced state may react directly with CO₂to produce an adduct, and the CO₂ can subsequently be released by oxidizing the adduct. In principle, the pure CO₂ obtained after separation can be converted back into useful chemical fuels and feedstocks with carbon-free energy, thus providing fuels and feedstocks without added CO₂ emissions.

### EXAMPLES

The invention will be further described by the following non-limiting examples.

### Example 1: Reduced 1,8-BTMAPAQ with Captured CO₂ Can Withstand the Presence of Air for 5 Days

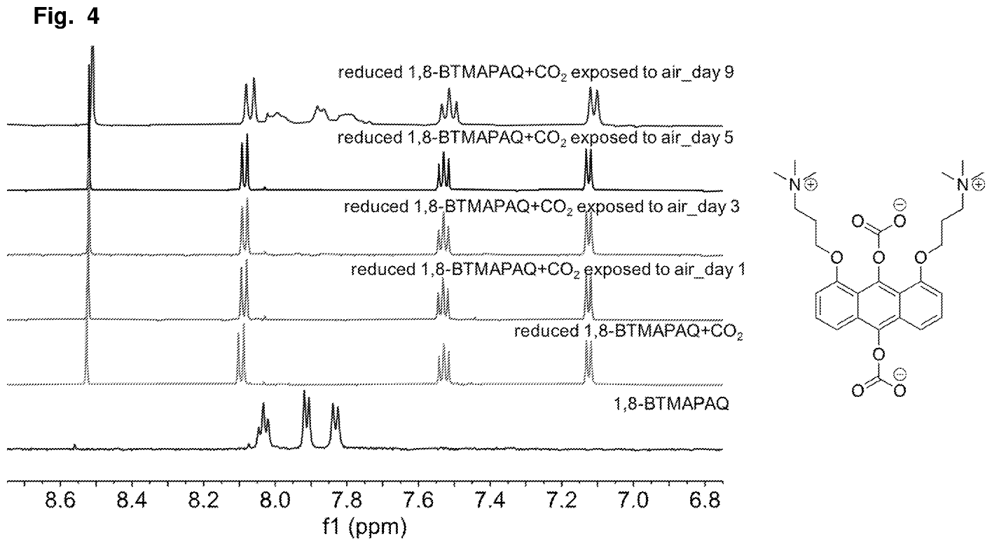

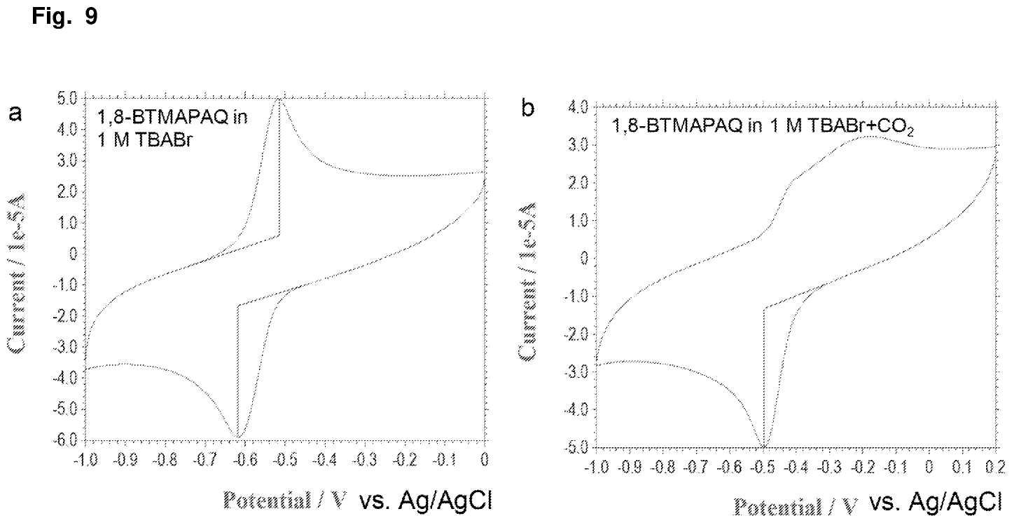

We first prepared the reduced 1,8-BTMAPAQ with captured CO₂ sample in D₂O in the presence of 1 M tetrabutylammonium bromide (TBABr). As we intentionally exposed the solution to air over nine days, we tracked its ¹H NMR spectra, which provides precise information about the bonding environment of the hydrogen atoms in molecules. As shown in FIG. 4, the sample with captured CO₂ demonstrates excellent air stability over the first five days, as indicated by the unchanged ¹H NMR spectra; the peaks from its oxidized form show up in the day-9 NMR spectrum. The ¹H NMR tracking study indicates that oxidation by air of the reduced species is extremely slow (kinetically unfavorable), despite still being thermodynamically favorable. Cyclic voltammetry experiments are shown in FIG. 9.

### Example 2: Reduced 1,4-BTMAPAQ with and without Captured CO₂

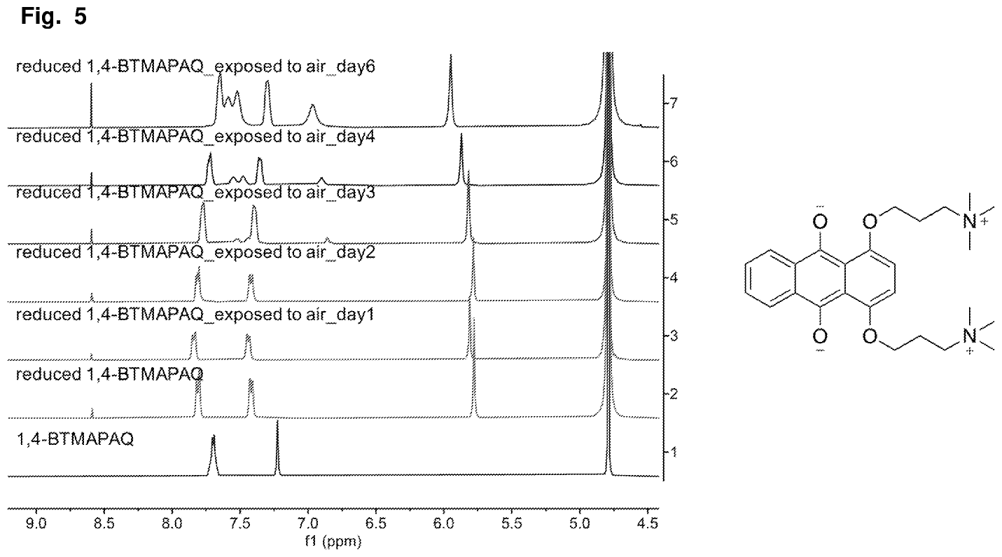

We prepared the reduced 1,4-BTMAPAQ sample in D₂O in the presence of 1 M KCl. As we intentionally exposed the solution to air over six days, we tracked its ¹H NMR spectra, which provides precise information about the bonding environment of the hydrogen atoms in molecules. As shown in FIG. 5, the sample demonstrates excellent air stability over the first two days, as indicated by the unchanged ¹H NMR spectra; the peaks from its oxidized form gradually show up in the spectra from day-3 to day-6. The ¹H NMR tracking study indicates that oxidation by air of the reduced species is very slow.

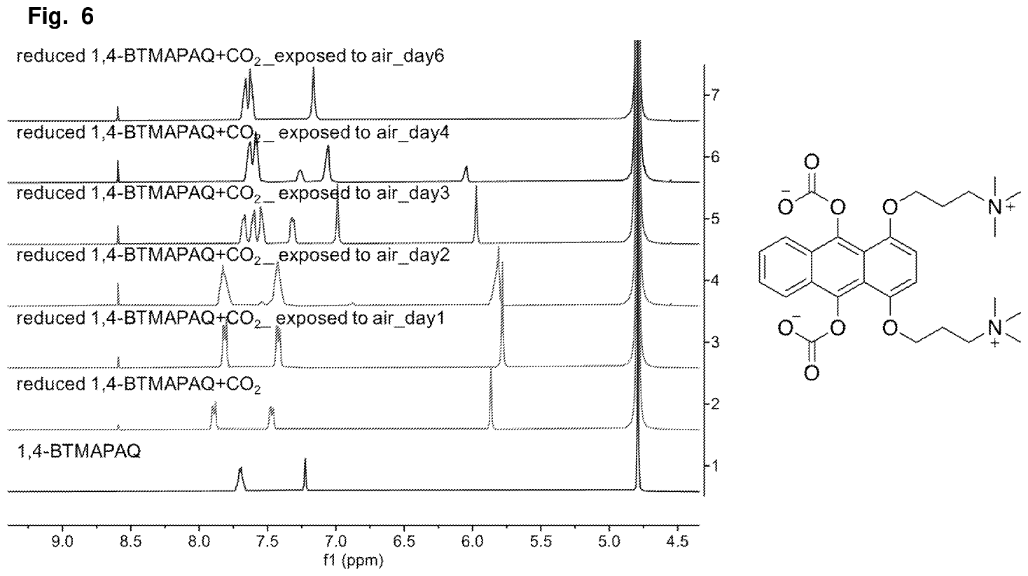

We prepared the reduced 1,4-BTMAPAQ with captured CO₂ sample in D₂O in the presence of 1 M KCl. As we intentionally exposed the solution to air over six days, we tracked its ¹H NMR spectra, which provides precise information about the bonding environment of the hydrogen atoms in molecules. As shown in FIG. 6, the sample demonstrates good air stability over the first two days, as indicated by the unchanged ¹H NMR spectra; the peaks from its oxidized form start to show up in the spectra on day-2 and completely convert to the peaks of the oxidized form on day-6. The ¹H NMR tracking study indicates that oxidation by air of the reduced species is relatively slow.

### Example 3: Reduced 1,5-BTMAPAQ with and without Captured CO₂

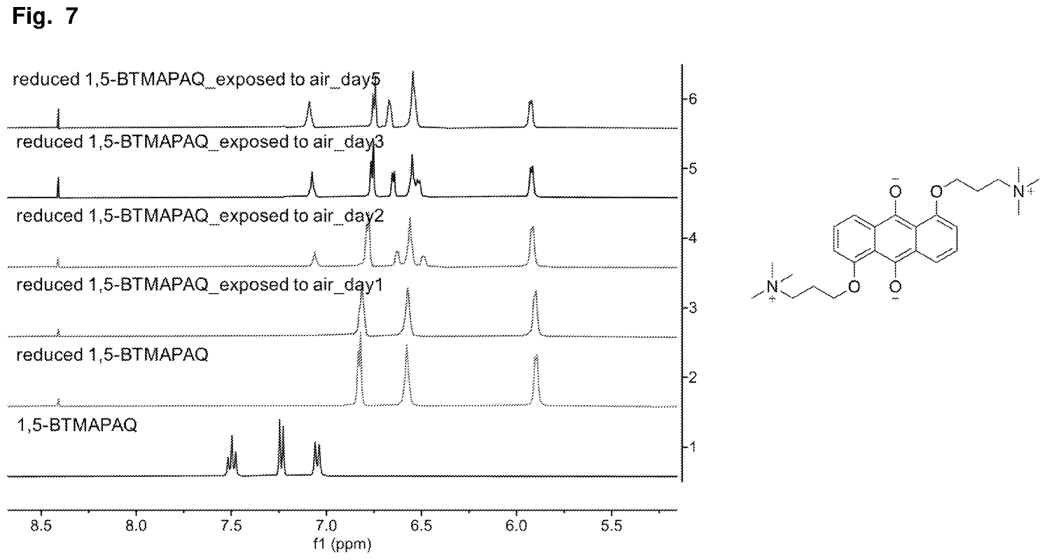

We prepared the reduced 1,5-BTMAPAQ sample in D₂O in the presence of 1 M KCl. As we intentionally exposed the solution to air over six days, we tracked its ¹H NMR spectra, which provides precise information about the bonding environment of the hydrogen atoms in molecules. As shown in FIG. 7, the sample demonstrates good air stability over the first day, as indicated by the unchanged ¹H NMR spectra; the peaks from its oxidized form gradually show up in the spectra from day-2 to day-6. The ¹H NMR tracking study indicates that oxidation by air of the reduced species is very slow.

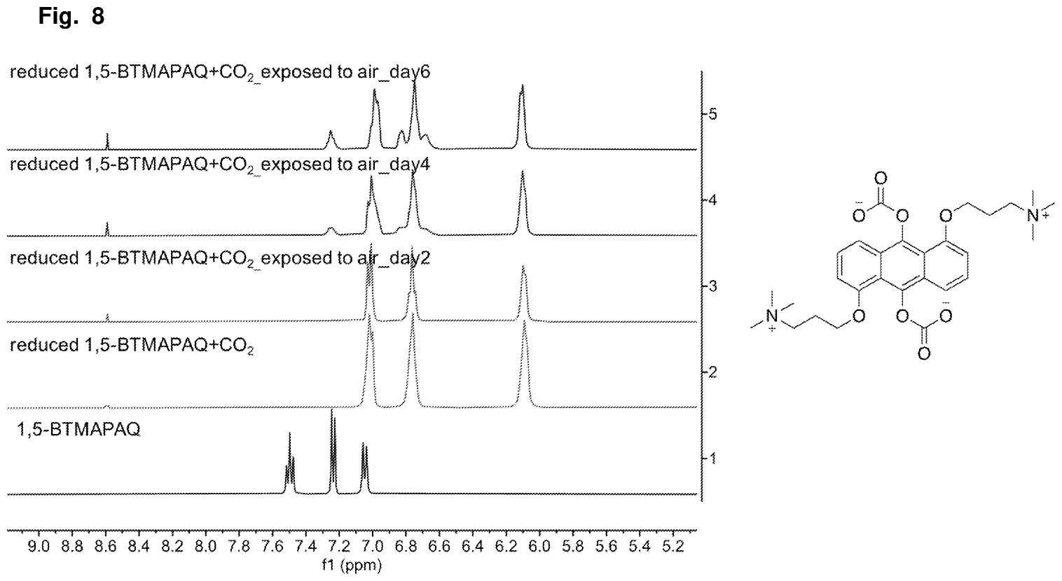

We prepared the reduced 1,5-BTMAPAQ with captured CO₂ sample in D₂O in the presence of 1 M KCl. As we intentionally exposed the solution to air over six days, we tracked its ¹H NMR spectra, which provides precise information about the bonding environment of the hydrogen atoms in molecules. As shown in FIG. 8, the sample demonstrates great air stability over the first two days, as indicated by the unchanged ¹H NMR spectra; the peaks from its oxidized form gradually show up in the spectra from day-4 to day-6. The ¹H NMR tracking study indicates that oxidation by air of the reduced species is very slow.

Preparation of the Reduced BTMAPAQ Isomer Samples First, 0.1 M BTMAPAQ isomers were dissolved in D₂O, 0.1 M sodium dithionite (Na₂S₂O₄) was added into the solutions to chemically reduce BTMAPAQ. At pH=7, the potential of Na₂S₂O₄ is −0.66 V vs. SHE, which is lower than the reduction potential of BTMAPAQ (−0.41 V vs. SHE). Therefore, Na₂S₂O₄ is chosen for the chemical reduction. The redox occurs with formation of sulfite and protons, S₂O₄²⁻+2H₂O →2 HSO₃⁻+2 e⁻+2 H⁺. To avoid the pH change while introducing Na₂S₂O₄, 0.2 M of KOH was added in advance to neutralize the produced protons. The solutions were immediately transferred to NMR tubes. For 1,8-BTMAPAQ, 1 M TBABr was added as the supporting salt additive, for 1,4- and 1,5-BTMAPAQ isomers, 1 M KCl was added as the supporting salt additive.

Preparation of the reduced BTMAPAQ isomer with captured CO₂ samples 0.1 M BTMAPAQ isomers were dissolved in D₂O, 0.1 M sodium dithionite (Na₂S₂O₄) was added into the solutions to chemically reduce BTMAPAQ, 0.2 M of KOH was added in advance to neutralize the produced protons. The solutions were immediately transferred to NMR tubes, and excess dry ice particulates were added to the tube to form organic carbonates.

### 1,8-BTMAPAQ-Based CO₂ Capture Experiment Procedures:

1. To a 50 ml three-neck flask, 0.5 mmol Na₂S₂O₄, 1.2 mmol KOH were added and purged with N2 for 30 mins.
2. 5 ml 0.1 M 1,8-BTMAP-AQ (0.5 mmol) in 1 M TBABr was injected to the flask for chemical reduction. (S₂O₄²⁻+2 OH⁻→2 HSO₃⁻+2 e⁻; Q+2 e⁻→Q²⁻)
3. The solution was then bubbled with CO₂ for 15 mins for quinone+CO₂ adduct formation.

Q²⁻+2 CO₂→Q(CO₂)₂²⁻
The adduct solution was purged with N2 for 15 mins to remove the headspace CO₂.
The adduct solution was exposed to air with rigorous stirring for 15 mins to examine the air stability of the water-soluble organic carbonate [Q(CO₂)₂²⁻], then the solution was purged with N2 for 5 mins to remove residual air.
4. The three-neck flask was connected to a flask containing 500 mL saturated Ba(OH)₂ solution with a double-ended needle. A N2-filled balloon was connected to the three-neck flask.
5. 2 ml 0.5 M potassium ferricyanide (1 mmol) solution was injected to the solution, and the generated CO₂ was transferred to Ba(OH)₂ solution by the N2 carrier gas.

2 Fe(CN)₆³⁻+Q(CO₂)₂²⁻→2 Fe(CN)₆⁴⁻+Q+CO₂ (g)

CO₂+Ba(OH)₂→BaCO₃ (s)+H₂O
6. The BaCO₃ suspensions were centrifugated and the solids were dried in a convection oven for 3 days, the products were weighed for 3 times until the mass did not change at all.

Each quinone can capture 2 CO₂ molecules. For example, 0.5 mmol 1,8-BTMPAQ may capture up to 1 mmol CO₂, leading to the precipitation of 1 mmol BaCO₃, i.e., 197 mg of BaCO₃ when CO₂ is released into Ba(OH)₂ solution. In this example, 200 mg BaCO₃ was captured in N2; and 170 mg BaCO₃ was captured when the solution with captured CO₂ was vigorously stirred in air. That is 1.7 CO₂ molecules per BTMPAQ were captured per quinone with air exposure, 0.3 CO₂ per 1,8-BTMPAQ escaped during the air exposure.

### Example 4

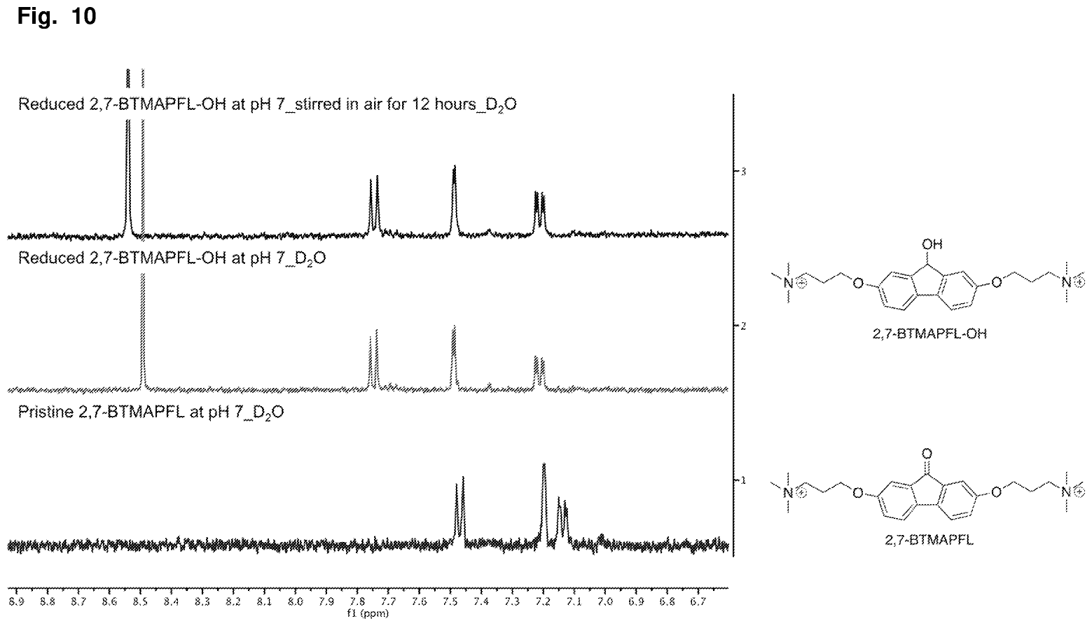

We prepared the reduced 2,7-BTMAPFL sample, i.e., 2,7-BTMAPFL-OH, in D₂O in the presence of 1 M KCl at pH 7. We vigorously stirred the solution in air for 12 hours, then checked its ¹H NMR spectra before and after being stirred in air. As shown in FIG. 10, the sample demonstrates excellent air stability over 12 hours, as indicated by the unchanged ¹H NMR spectra.

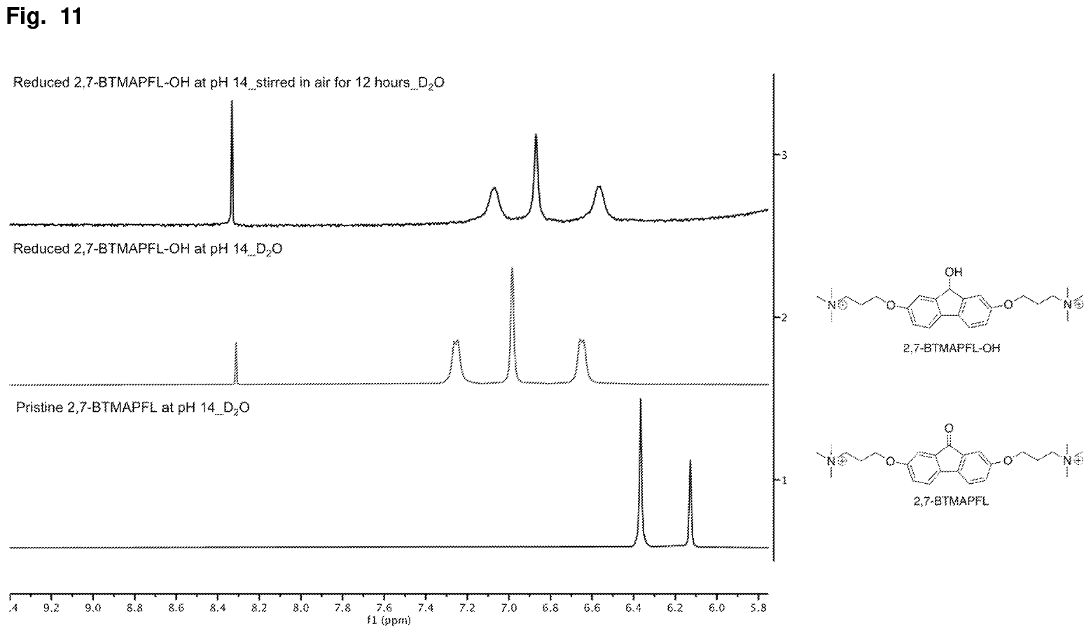

The 2,7-BTMAPFL molecule undergoes PCET process and forms 2,7-BTMAPFL-OH after the electrochemical reduction; meanwhile, the electrolyte pH swings from near neutral (˜7) to ˜14. Therefore, we also investigated the air stability of 2,7-BTMAPFL-OH at pH 14 by vigorously stirring the pH 14 solution in air for 12 hours. As shown in FIG. 11, the sample demonstrates excellent air stability over 12 hours, as indicated by the almost unchanged ¹H NMR spectra.

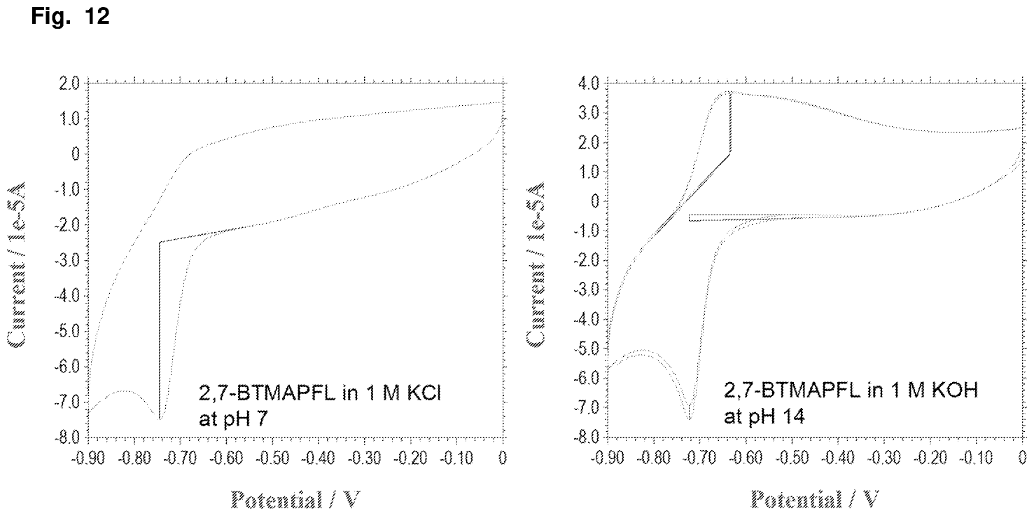

The cyclic voltammetry experiments are shown in FIG. 12. 2,7-BTMAPFL demonstrates good reversibility at pH 14, but poor reversibility at pH 7. A mediator or a catalyst could be employed to improve its electrochemical reversibility at pH 7.

Other embodiments are in the claims.

What is claimed is:

1. A method for capturing CO₂ comprising:
a) providing an electrochemical cell comprising a redox-active species dissolved or dispersed in aqueous solution;
b) electrochemically reducing the redox-active species to a reduced state; and
c) contacting a mixture of gases comprising CO₂ with the aqueous solution;
wherein the redox-active species comprises an aromatic redox core and one or more substituents which increase resistance of the reduced state to oxidation by oxygen or wherein a redox potential of the redox-active species and its reduced state is stable to oxidation by oxygen.

2. The method of claim 1, wherein the one or more substituents comprises one or more electron withdrawing groups.

3. The method of claim 2, wherein the electron withdrawing groups are separated from the redox core by —(CH₂)₁₋₆—, —O(CH₂)₀₋₆—, —S(CH₂)₀₋₆—, —NH(CH₂)₀₋₆—, or —NRₐ(CH₂)₀₋₆—.

4. The method of claim 1, wherein the one or more substituents comprise one or more groups selected from —NO₂, —CN, —SO₃Rₐ, —CHO, —C(═O)Rₐ, —C(═O)O C(═O)Rₐ, —C(═O)ORₐ, —CONH₂, —COO⁻, —NRₐ₃⁺, —CF₃, —SO₂Rₐ, —F, —Cl, —Br, —I, —ORₐ, —SRₐ, —P(═O)(ORₐ)₂,—(CH₂)₁₋₃NO₂, —(CH₂)₁₋₃CN, —(CH₂)₁₋₃SO₃Rₐ, —(CH₂)₁₋₃CHO, —(CH₂)₁₋₃C(═O)Rₐ, —(CH₂)₁₋₃C(═O)OCORₐ, —(CH₂)₁₋₃COORₐ, —(CH₂)₁₋₃C(═O)OH, —(CH₂)₁₋₃CONH₂, —(CH₂)₁₋₃C(═O)O—, —(CH₂)₁₋₃NRₐ₃,—(CH₂)₁₋₃SO₂Rₐ, —CH₂CF₃, —CH₂CCl₃, —CH₂CBr₃, —CH₂Cl₃, —CH₂CHF₂, —CH₂CHCl₂, —CH₂CHBr₂, —CH₂CHI₂, —CH₂(CF₂)₁₋₆CF₃,—(CH₂)₁₋₃ORₐ, and —(CH₂)₁₋₃SRₐ, wherein each Rₐ is independently H; optionally substituted C₁₋₆ alkyl; optionally substituted C₃₋₁₀ carbocyclyl; or optionally substituted C₁₋₉ heterocyclyl having one to four heteroatoms independently selected from O, N, and S.

5. The method of claim 1, wherein the one or more substituents are optionally substituted C₁₋₆ alkyl groups comprising a quaternary ammonium group, optionally substituted C₁₋₆ alkoxy groups comprising a quaternary ammonium group, or optionally substituted C₁₋₆ alkyl thio groups comprising a quaternary ammonium group.

6. The method of claim 1, wherein the one or more substituents comprise at least one —(CH₂)₁₋₁₁NRₐ3⁺ group, wherein each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

7. The method of any one of claims 1-6, wherein the aromatic redox core is para or ortho benzoquinone, naphthoquinone, anthraquinone, phenanthrenequinone, fluorenone, benzophenone, anthrone, xanthone, thioxanthone, acridone, phenazine, viologen, alloxazine, isoalloxazine, azobenzene, phthalimide, phenothiazine, naphthalimide, pyromellitic diimide, 1,4,5,8-naphthalenetetracarbodiimide, or benzo(c)cinnoline.

8. The method of claim 7, wherein the redox-active species has the formula: 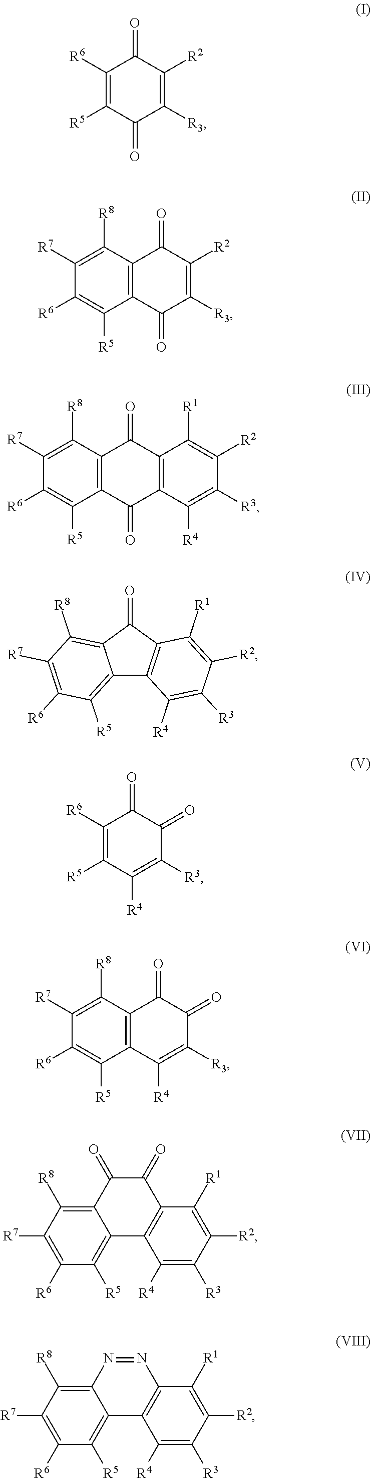 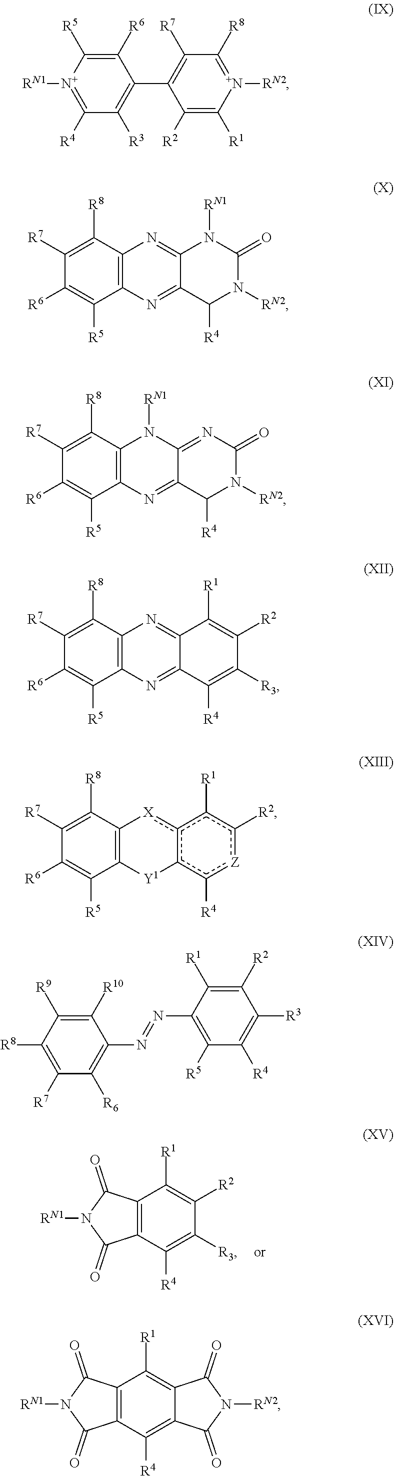 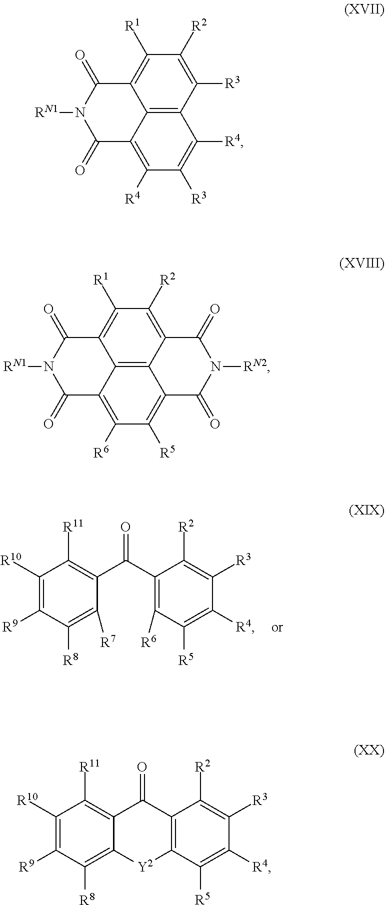
wherein dashed bonds are single or double bonds;
wherein X is N or NR^{X}, Y₁ is O or S, Y₂ is C(R⁶)₂, NR^{Y}, S, O, and Z is CR⁶, C═O, C═S, C═NR^{Z}, or C═NH⁺R^{Z};
wherein each R^{N1}, R^{N2}, R^{X}, R^{Y}, and R^{Z} is independently selected from —CH₂R^{EWG}; —CH₂R^{QA}; H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; and a nitrogen protecting group;
wherein each of R¹, R², R³, R⁴, R⁵, R⁶, R⁷, R⁸, R⁹, and R¹⁰ is independently selected from R^{EWG}; R^{QA}; H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; and —P(═O)Rₐ₂; —P(═O)(ORₐ)₂; or any two adjacent groups selected from R¹, R², R³, and R⁴ are joined to form an optionally substituted 3-6 membered ring, or an ion thereof, wherein each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; and a nitrogen protecting group;
wherein each R^{EWG} is independently selected from —NO₂, —CN, —SO₃Rₐ, —CHO, —C(═O)Rₐ, —C(═O)O C(═O)Rₐ, —C(═O)ORₐ, —CONH₂, —COO⁻, —NRₐ₃⁺, —CF₃, —SO₂Rₐ, —F, —Cl, —Br, —I, —ORₐ, —SRₐ, —P(═O)(ORₐ)₂,—(CH₂)₁₋₃NO₂, —(CH₂)₁₋₃CN, —(CH₂)₁₋₃SO₃Rₐ, —(CH₂)₁₋₃CHO, —(CH₂)₁₋₃C(═O)Rₐ, —(CH₂)₁₋₃C(═O)OCORₐ, —(CH₂)₁₋₃COORₐ, —(CH₂)₁₋₃C(═O)OH, —(CH₂)₁₋₃CONH₂, —(CH₂)₁₋₃C(═O)O—, —(CH₂)₁- ₃NRₐ₃⁺,—(CH₂)₁₋₃SO₂Rₐ, —CH₂CF₃, —CH₂CCl₃, —CH₂CBr₃, —CH₂Cl₃, —CH₂CHF₂, —CH₂CHCl₂, —CH₂CHBr₂, —CH₂CHI₂, —CH₂(CF₂)₁₋₆CF₃,—(CH₂)₁₋₃ORₐ, and —(CH₂)₁₋₃SRₐ, wherein each Rₐ is independently H;
optionally substituted C₁₋₆ alkyl; optionally substituted C₃₋₁₀ carbocyclyl; or optionally substituted C₁₋₉ heterocyclyl having one to four heteroatoms independently selected from O, N, and S;
wherein each R^{QA} is independently selected from —(CH₂)₁₋₆NRₐ₃⁺, —O(CH₂)₁₋₆NRₐ₃⁺, —S(CH₂)₁₋₆NRₐ₃⁺, —NRₐ(CH₂)₁₋₆NRₐ₃⁺, and —N((CH₂)₁₋₆NRₐ₃⁺)₂, wherein each Rₐ is independently H; optionally substituted C₁₋₆ alkyl; optionally substituted C₃₋₁₀ carbocyclyl; or optionally substituted C₁₋₉ heterocyclyl having one to four heteroatoms independently selected from O, N, and S;
wherein at least one of R¹, R², R³, R⁴, R⁵, R⁶, R⁷ and R⁸ is R^{EWG} or R^{QA} and/or at least one R^{N1}, R^{N2}, R^{X}, R^{Y}, or R^{Z}, is —CH₂R^{EWG} or —CH₂R^{QA}.

9. The method of claim 1, wherein the redox-active species is:

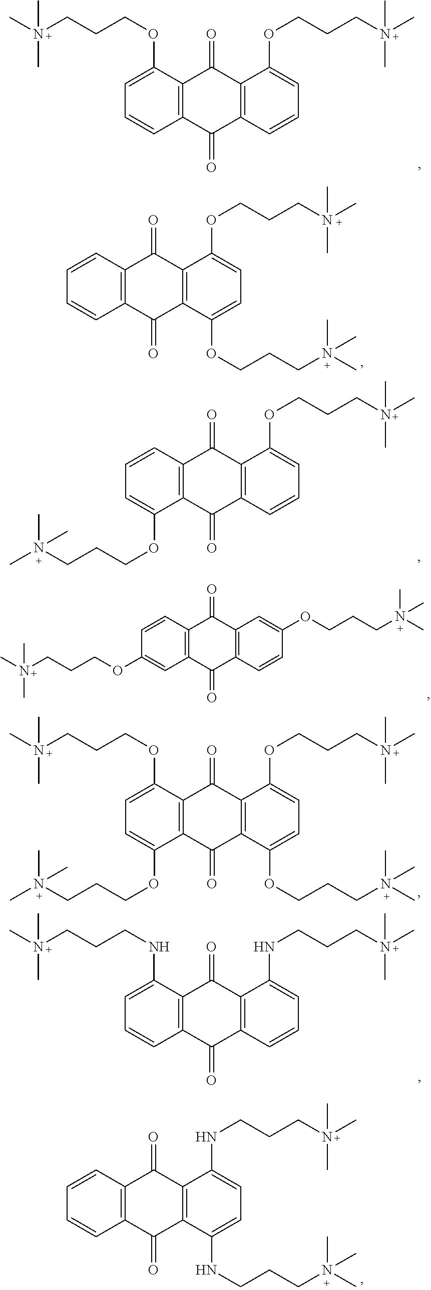

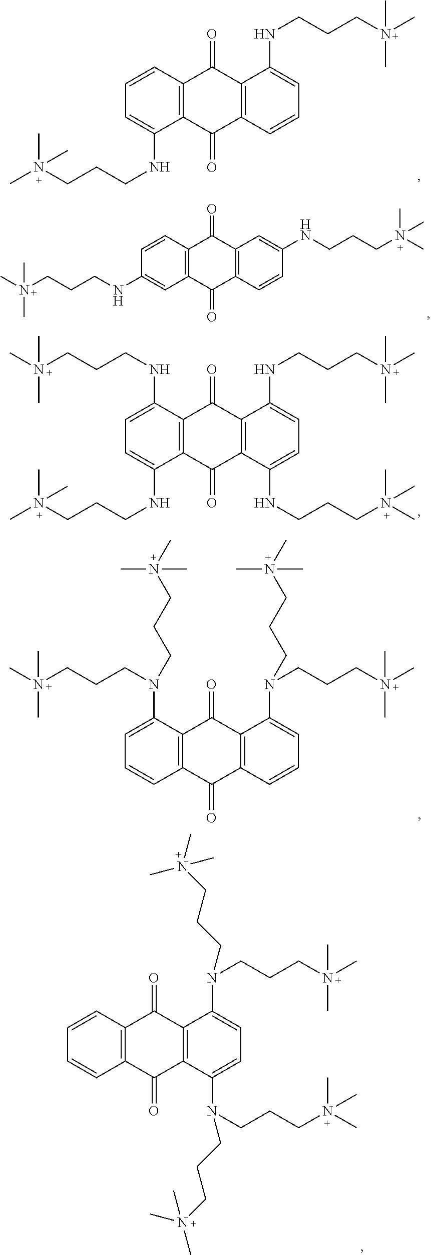

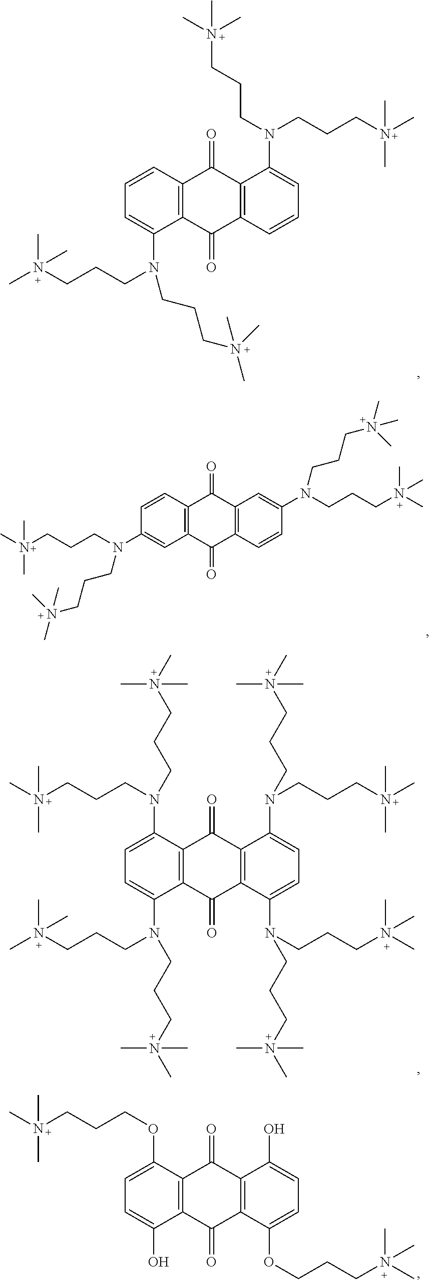

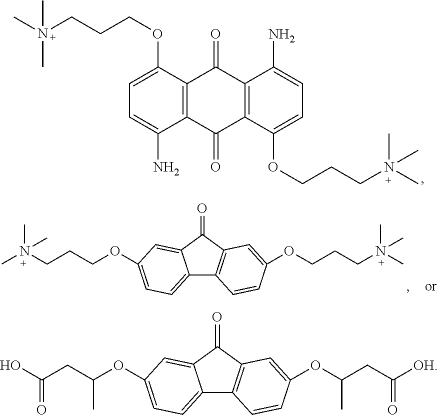

10. The method of any one of claims 1-9, wherein step b) produces hydroxide ions and step c) comprises forming inorganic carbonates.

11. The method of any one of claims 1-9, wherein the reduced state reacts with one or more CO₂ molecules to form a CO₂ adduct.

12. The method of any one of claims 1-11, wherein in step (b) the reduced state reacts with water to produce one or more hydroxide ions.

13. The method of any one of claims 1-12, further comprising electrochemically oxidizing the reduced state to release CO₂.

14. The method of claim 1, wherein the redox-active species is an inorganic redox-active species.

15. The method of claim 14, wherein the redox-active species comprises a nitrate anion and the reduced state comprises a nitrite anion.

16. The method of claim 14 or 15, wherein the aqueous solution comprises a catalyst or enzyme to reduce an overpotential of reduction of the redox-active species and/or oxidation of the reduced state.

17. The method of claim 16, wherein the catalyst comprises Pt, Ir, Pd, Ni, Rh, Ru, Zn, Cu, Fe, or Co, or a combination thereof; or wherein the catalyst comprises an aminoxyl radical or phthalimido-N-oxyl radical;
or wherein the enzyme is an alcohol dehydrogenase.

18. The method of any one of claims 15-17, further comprising oxidizing the nitrite anion to a nitrate anion and releasing the captured CO₂.
